(19) United States
(12) Patent Application Publication
(10) Pub. No.: US 2025/0204525 A1
(43) Pub. Date: Jun. 26, 2025

(54) ANTIMICROBIAL COMPOSITIONS

(71) Applicant: Curie Co. Inc., Durham, NC (US)

(72) Inventors: Erika MILCZEK, Durham, NC (US); Christian KASEY, Cary, NC (US); Ryan WOODYER, Dallas, GA (US); Will SHINDEL, Durham, NC (US); Marley ADAMEK, Cary, NC (US); John MCARTHUR, Morrisville, NC (US); Jaina Ashwinkumar BHAYANI, Raleigh, NC (US)

(21) Appl. No.: 18/737,768

(22) Filed: Jun. 7, 2024

Related U.S. Application Data
(63) Continuation of application No. PCT/US2024/024816, filed on Apr. 16, 2024.
(60) Provisional application No. 63/614,360, filed on Dec. 22, 2023.

(51) Int. Cl. A01N 33/02; A01N 37/10; A01P 1/00

(52) U.S. Cl. CPC A01N 33/02; A01N 37/10; A01P 1/00

(57) ABSTRACT

Polycationic ingredients for use in improving the efficacy of known organic acid compositions at neutral to basic pH, and/or reducing the amount of organic acids needed for antimicrobial activity. Methods of boosting antimicrobial activity of organic acid compositions is achieved through adding a polycationic compound. Use of the antimicrobial compositions in products is also described.

### FIELD OF INVENTION

The field pertains to using polycationic compounds to facilitate the use of organic acids at about neutral and elevated pH for product preservation, antimicrobial applications, and/or product performance.

### BACKGROUND

The ingredients and composition of many personal care, cosmetic, household products, healthcare products, industrial products, pharmaceutical products, food and beverage products, and consumer products provide viable growth medium for microorganisms. If water is present in a product or process, risk of microbial contamination is greater. As such, antimicrobial ingredients are needed to inhibit the growth of microorganisms to prevent or deter growth of microorganisms and maintain the integrity of the products when used over time or in storage. For centuries, organic acids have been used as antimicrobial agents for the preservation of food and beverages. More recently, organic acids have been employed in the preservation of cosmetics and household cleaning products as regulation of traditional preservatives grows more stringent.

Certain organic acids, such as benzoic acid, are popular in consumer products due to low cost, ecofriendly profile, and water solubility. However, these acids may have limited utility for preservation above certain pH ranges. For example, benzoic acid is most effective to inhibit growth of microorganisms between pH 2.5 to pH 4.0, and with certain antimicrobial boosters or anionic surfactants, can be used to effectively inhibit microbial growth up to pH 6.5. The recommended use levels for sodium benzoate (benzoic acid's conjugate salt) in rinse-off personal care products is 0.1-1.0% while the recommended use levels for leave-on personal care products is 0.1-0.5%. In food and beverage, sodium benzoate is typically limited to 0.1% or less, and its use is typically limited to pH 4.0 or below. The effective pH range of sodium benzoate and permitted concentrations ranges further limit the tools available to formulators to achieve microbial control in leave on personal care products and in food and beverage. Unfortunately, the narrow effective pH range of organic acids, such as benzoic acid, for antimicrobial activity limits their utility in neutral pH products such as cleaning products, paints, coatings, adhesives, topical creams, and shampoo where product formulation at near neutral or basic pH is required for product performance.

Inexpensive antimicrobial compounds that effectively preserve neutral-pH products and processes are limited to biocides such as isothiazolinones, formaldehyde, formaldehyde releasers, and other highly sensitizing, corrosive, and/or irritating molecules. There is thus a need for safe, low cost, and effective preservatives at neutral pH.

### SUMMARY

Herein we disclose an antimicrobial composition comprising a cationic polymer with an organic acid wherein the antimicrobial activity of the organic acid is enhanced at elevated pH, e.g. pH at least 1.5 units higher than the organic acid's pKa in water. The present disclosure illustrates an extension of the useful pH range for organic acids as preservatives. In certain embodiments, this disclosure provides use of cationic polymers to extend the useful pH range of organic acids, such as benzoic acid, above pH values of 6.5 for microbial control. This invention allows the organic acid to be used at a higher pH than it would normally be effective and additionally allows the organic acid to be dosed at a lower concentration when the cationic polymer is present relative to the same product at the same pH containing the organic acid without the cationic polymer. The composition can be used to inhibit microbial growth in a product, especially a product of neutral to basic pH, addressing an unmet challenge in the field. We further disclose methods for preserving and extending the shelf life of a product, especially a product of neutral or basic pH, by adding an effective amount of the antimicrobial composition to the product. Products comprising an effective amount of the antimicrobial composition as a preservative is also disclosed. The use of cationic polymers and organic acids for preservation is compatible with other conventional chemical preservatives or biological based antimicrobials (e.g., peptides, proteins, and enzymes).

In a first embodiment, the product comprises an antimicrobial composition, wherein the antimicrobial composition comprises an ammonium-containing cationic polymer and sodium benzoate, wherein the concentration of sodium benzoate in the product is about 1% or lower by weight, and wherein the pH of the product is 6.0 or greater.

In a second embodiment, the product comprises an antimicrobial composition, wherein the antimicrobial composition comprises an ammonium-containing cationic polymer and sodium benzoate, wherein the sodium benzoate in the product is about 0.5% or lower by weight and the pH of the product is about 7.0 or lower, and wherein the product has improved antimicrobial efficacy compared to an identical product that does not comprise the ammonium-containing cationic polymer.

In a third embodiment, the ammonium-containing cationic polymer in the product of the first or the second embodiment has a molecular weight of about 800 g/mol to about 1,000,000 g/mol.

In a fourth embodiment, the concentration of the ammonium-containing cationic polymer in the product of any of the first three embodiments is about 0.0001% to about 0.1% by weight.

In a fifth embodiment, the ammonium-containing cationic polymer in the product of any of the first four embodiments is a primary ammonium-containing polymer, a secondary ammonium-containing polymer, a tertiary ammonium-containing polymer, a quaternary ammonium-containing polymer, and/or a copolymer thereof.

In a sixth embodiment, the ammonium-containing cationic polymer in the product of any of the first five embodiments comprises ethyleneimine, dimethylamine, epichlorohydrin, aziridine, ethylenediamine, diallyl dimethyl ammonium chloride, and/or acrylamide.

In a seventh embodiment, the ammonium-containing cationic polymer in the product of any of the first five embodiments is selected from a linear polyethylenimine, a branched polyethylenimine, a dimethylamine-epichlorohydrin copolymer, a dimethylamine-epichlorohydrin-ethylenediamine copolymer, or polyquaternium-7, and the concentration of the ammonium-containing cationic polymer in the product is about 0.00015% to about 0.0055% by weight.

In an eighth embodiment, the ratio by weight between the ammonium-containing cationic polymer and benzoic acid in the product of any of the first seven embodiments is from 1:10 to 1:2,000, and more specifically from 1:400 to 1:1,700.

In a ninth embodiment, the product of any of the first eight embodiments is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.

In a tenth embodiment, the product of the ninth embodiment is a personal care product selected from bar soap, liquid soap, hand sanitizer, preoperative skin disinfectant, cleansing wipes, disinfecting wipes, body wash, acne treatment products, antifungal diaper rash cream, antifungal skin cream, shampoo, conditioner, cosmetic, deodorant, antimicrobial cream, body lotion, hand cream, topical cream, aftershave lotion, skin toner, mouth wash, toothpaste, and sunscreen lotion.

In an eleventh embodiment, the product of any of the first ten embodiments is at about pH 6.0 to about pH 8.0.

In a twelfth embodiment, the product of any of the first eleven embodiments further comprises at least one antimicrobial enzyme, peptide, and/or protein.

In a thirteenth embodiment, the at least one antimicrobial enzyme, peptide, and/or protein in the product of the twelfth embodiment is selected from transglutaminase, lysozyme, chitinase, lipase, lysin, lysostaphin, glucanase, DNase, RNase, lactoferrin, glucose oxidase, peroxidase, lactoperoxidase, lactonase, acylase, dispersin B, a-amylase, cellulase, nisin, bacteriocin, siderophore, polymyxin, and defensin.

In a fourteenth embodiment, the product of any of the first thirteen embodiments further comprises at least one additional antimicrobial chemical.

In a fifteenth embodiment, the at least one additional antimicrobial chemical in the fourteenth embodiment is selected from a polymer, a quaternary ammonium compound, a detergent, a chaotropic agent, an organic acid, a phenol, an alcohol, a polyol, an aldehyde, an aldehyde releaser, a base, an oxidizer, a chelator, and a paraben.

In a sixteenth embodiment, the at least one additional antimicrobial chemical in the fourteenth embodiment is selected from phenoxyethanol, caprylyl glycol, ethylhexylglycerin, hexanediol, propanediol, coco betaine, sorbic acid, ethylenediaminetetracetic acid (EDTA), and chitosan.

In a seventeenth embodiment, the method of increasing the shelf life of a product comprises incorporating an antimicrobial composition into the product in an amount effective to provide antimicrobial activity in comparison to an identical product that does not comprise the antimicrobial composition, wherein the antimicrobial composition comprises an ammonium-containing cationic polymer and sodium benzoate wherein the concentration of sodium benzoate in the product is about 1% or lower by weight, and the product is at about pH 6.0 or higher.

In an eighteenth embodiment, the method of preserving a product comprises incorporating an antimicrobial composition into the product in an amount effective to provide antimicrobial activity in comparison to an identical product that does not comprise the antimicrobial composition, wherein the antimicrobial composition comprises an ammonium-containing cationic polymer and sodium benzoate wherein the concentration of sodium benzoate in the product is about 1% or lower by weight, and the product is at about pH 6.0 or higher.

In a nineteenth embodiment, the product of the seventeenth or the eighteenth embodiment is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.

In a twentieth embodiment, the product of the nineteenth embodiment is a personal care product selected from bar soap, liquid soap, hand sanitizer, preoperative skin disinfectant, cleansing wipes, disinfecting wipes, body wash, acne treatment products, antifungal diaper rash cream, antifungal skin cream, shampoo, conditioner, cosmetic, deodorant, antimicrobial cream, body lotion, hand cream, topical cream, aftershave lotion, skin toner, mouth wash, toothpaste, and sunscreen lotion.

In a twenty-first embodiment, the concentration of the ammonium-containing cationic polymer in the product of any of the seventeenth to the twentieth embodiments is about 0.0001% to about 0.1% by weight.

In a twenty-second embodiment, the product of any of the seventeenth to the twenty-first embodiments is at about pH 6.0 to about pH 8.0.

In a twenty-third embodiment, the antimicrobial composition comprises an ammonium-containing cationic polymer and sodium benzoate, wherein the antimicrobial composition has antimicrobial activity from about pH 6.0 to about pH 8.0 when incorporated into a product at amounts of less than 1% sodium benzoate in the product.

In a twenty-fourth embodiment, the ammonium-containing cationic polymer in the antimicrobial composition of the twenty-third embodiment has a molecular weight of about 800 g/mol to about 1,000,000 g/mol.

In a twenty-fifth embodiment, the ammonium-containing cationic polymer in the antimicrobial composition of the twenty-third or the twenty-fourth embodiment is a primary ammonium-containing polymer, a secondary ammonium-containing polymer, a tertiary ammonium-containing polymer, a quaternary ammonium-containing polymer, and/or a copolymer thereof.

In a twenty-six embodiment, the ammonium-containing cationic polymer in the antimicrobial composition of any of the twenty-third to the twenty-fifth embodiments comprises ethyleneimine, dimethylamine, epichlorohydrin, aziridine, ethylenediamine, diallyl dimethyl ammonium chloride, and/or acrylamide.

In a twenty-seventh embodiment, the ammonium-containing cationic polymer in the antimicrobial composition of any of the twenty-third to the twenty-fifth embodiments is selected from a linear polyethylenimine, a branched polyethylenimine, a dimethylamine-epichlorohydrin copolymer, a dimethylamine-epichlorohydrin-ethylenediamine copolymer, or polyquaternium-7.

In a twenty-eighth embodiment, the ratio by weight between the ammonium-containing cationic polymer and sodium benzoate in the antimicrobial composition of any of the twenty-third to the twenty-seventh embodiments is from 1:10 to 1:2,000, and more specifically from 1:400 to 1:1,700.

In a twenty-ninth embodiment, the antimicrobial composition of any of the twenty-third to the twenty-eighth embodiments further comprises at least one antimicrobial enzyme, peptide, and/or protein.

In a thirtieth embodiment, the at least one antimicrobial enzyme, peptide, and/or protein in the antimicrobial composition of the twenty-ninth embodiment is selected from transglutaminase, lysozyme, chitinase, lipase, lysin, lysostaphin, glucanase, DNase, Rnase, lactoferrin, glucose oxidase, peroxidase, lactoperoxidase, lactonase, acylase, dispersin B, a-amylase, cellulase, nisin, bacteriocin, siderophore, polymyxin, and defensin.

In a thirty-first embodiment, the antimicrobial composition of any of the twenty-third to the thirtieth embodiments further comprises at least one additional antimicrobial chemical.

In a thirty-second embodiment, the at least one additional antimicrobial chemical in the antimicrobial composition of the thirty-first embodiment is selected from a polymer, a quaternary ammonium compound, a detergent, a chaotropic agent, an organic acid, a phenol, an alcohol, a polyol, an aldehyde, an aldehyde releaser, a base, an oxidizer, a chelator, and a paraben.

In a thirty-third embodiment, the at least one additional antimicrobial chemical in the antimicrobial composition of the thirty-first embodiment is selected from phenoxyethanol, caprylyl glycol, ethylhexylglycerin, hexanediol, propanediol, coco betaine, sorbic acid, ethylenediaminetetracetic acid (EDTA), and chitosan.

In a thirty-fourth embodiment, the antimicrobial composition of any of the twenty-third to the thirty-third embodiments is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product, and sodium benzoate is about 1% or lower by weight.

In a thirty-fifth embodiment, the antimicrobial composition of the thirty-fourth embodiment is a personal care product selected from bar soap, liquid soap, hand sanitizer, preoperative skin disinfectant, cleansing wipes, disinfecting wipes, body wash, acne treatment products, antifungal diaper rash cream, antifungal skin cream, shampoo, conditioner, cosmetic, deodorant, antimicrobial cream, body lotion, hand cream, topical cream, aftershave lotion, skin toner, mouth wash, toothpaste, and sunscreen lotion, and sodium benzoate is about 1% or lower by weight.

### BRIEF DESCRIPTION OF THE FIGURES

FIG. 1 depicts the antibacterial challenge testing results of unpreserved foaming hand soap portions inoculated with a pool of E. coli, P. aeruginosa, and S. aureus at pH 6.5, 7.0, 7.5, or 8.0.

FIG. 2 depicts the antibacterial challenge testing results of foaming hand soap portions containing 0.5% sodium benzoate at pH 6.5 or 1% sodium benzoate at pH 7.0, 7.5, or 8.0, wherein the foaming hand soap portions were inoculated with a pool of E. coli, P. aeruginosa, and S. aureus.

FIG. 3 depicts the antibacterial challenge testing results of foaming hand soap portions (pH 7.0) containing 0.0025% of one of polymer nos. 1-5 and inoculated with a pool of E. coli, P. aeruginosa, and S. aureus.

FIGS. 4A-E depict the antimicrobial challenge testing results of foaming hand soap portions (pH 7.0) containing one of polymer nos. 6-9 and inoculated with E. coli (FIG. 4A), P. aeruginosa (FIG. 4B), S. aureus (FIG. 4C), A. brasiliensis (FIG. 4D), or C. albicans (FIG. 4E), respectively.

FIGS. 5A-E depict the antimicrobial challenge testing results of foaming hand soap portions (pH 7.0) containing 1% sodium benzoate and 0.0025% of one of polymer nos. 1-5 and inoculated with E. coli (FIG. 5A), P. aeruginosa (FIG. 5B), S. aureus (FIG. 5C), A. brasiliensis (FIG. 5D), or C. albicans (FIG. 5E), respectively.

FIGS. 6A-E depict the antimicrobial challenge testing results of foaming hand soap portions (pH 7.0) containing 1% sodium benzoate and one of polymer nos. 6-9 and inoculated with E. coli (FIG. 6A), P. aeruginosa (FIG. 6B), S. aureus (FIG. 6C), A. brasiliensis (FIG. 6D), or C. albicans (FIG. 6E), respectively.

### DETAILED DESCRIPTION

All patents, patent applications, and publications cited herein are incorporated by reference in their entireties.

### Definitions

Words using the singular include the plural, and vice versa, unless the context clearly dictates otherwise.

In this disclosure, many terms and abbreviations are used. The following definitions apply unless specifically stated otherwise.

As used herein, the singular forms “a,” “an,” and “the” include plural references unless the context clearly dictates otherwise. For example, the term “a compound” or “at least one compound” may include a plurality of compounds, including mixtures thereof. The terms “a,” “an,” “the,” “one or more,” and “at least one,” for example, can be used interchangeably herein.

The term “about” as used herein can allow for a degree of variability in a value or range of at most within 10%, e.g., within 5%, or within 1% of a stated value or of a stated limit of a range.

The terms “and/or” and “or” are used interchangeably herein and refer to a specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B and/or C” is intended to encompass each of the following aspects: “A, B and C”; “A, B or C”; “A or C”; “A or B”; “B or C”; “A and C”; “A and B”; “B and C”; “A” (alone); “B” (alone); and “C” (alone).

Throughout this application, various embodiments can be presented in a range format. It should be understood that the description in range format is merely for convenience and brevity and should not be construed as an inflexible limitation on the scope of the embodiments described herein. Accordingly, the description of a range should be considered to have specifically disclosed all the possible subranges as well as individual numerical values within that range. For example, description of a range, such as from 1 to 6 should be considered to have subranges such as from 1 to 2, from 1 to 3, from 1 to 4 and from 1 to 5, from 2 to 3, from 2 to 4, from 2 to 5, from 2 to 6, from 3 to 4, from 3 to 5, from 3 to 6, etc., as well as individual numbers within that range, for example, 1, 2, 3, 4, 5 and 6. This applies regardless of the breadth of the range.

“Optional” or “optionally” means that the subsequently described event, circumstance, or material may or may not occur or be present, and that the description includes instances where the event, circumstance, or material occurs or is present and instances where it does not occur or is not present.

The term “antimicrobial” refers to any agent or combination of agents that kills, inactivates, or inhibits the growth of any microbes such as bacteria, archaea, protozoa, fungi, algae, amoebas, viruses and the like. Antimicrobials can be biocides, biostats, disinfectants, boosters, and preservatives. In some cases, antimicrobials can work in synergy or have additive effects which may enhance their effectiveness. Antimicrobials that demonstrate additive, potentiating, or synergistic effects are often referred to as boosters. Some antimicrobials are multifunctional agents, which may have multiple benefits including antimicrobial properties. Examples of antimicrobials include, but are not limited to, antimicrobial chemicals, antimicrobial polymers, antimicrobial proteins, antimicrobial enzymes, and antimicrobial peptides. The term “antibacterial” refers to any agent or combination of agents that kills, inactivates, or inhibits the growth of bacteria. In certain cases, an antibacterial agent can also act on non-bacterial microbes.

The term “broad spectrum antimicrobial” is one that acts against a wide range of microorganisms, for example Gram-positive bacteria, Gram-negative bacteria, yeast, mold, viruses, etc.

The term “Cleaning in Place” (CIP) refers to a method used to clean and sanitize equipment and pipelines without dismantling them. The CIP process involves circulating a cleaning solution through the equipment and piping using pumps, while valves and control systems regulate the flow rate and pressure. The cleaning solution is typically a mixture of water and cleaning agents, including antimicrobial agents, detergents, acids, or alkalis, depending on the type of equipment being cleaned and the type of soil to be removed. CIP is widely used in various industries, including food and beverage, pharmaceuticals, cosmetics, and biotechnology, to ensure equipment cleanliness and product quality while minimizing downtime and labor costs. Additionally, substances to maintain sanitary conditions or a reasonable microbial load during processing may be added as processing aids. These processing aids may be added directly to manufacturing streams in order to maintain sanitary conditions and reduce microbial load (i.e., the number and type of microorganisms present) in processing steps. The processing aids have a technical effect during processing only but are either not present at significant levels in the final product or have no functional or technical effect in the final product.

The term “decontamination” used herein describes a process wherein a raw material, a final product, a waste stream (produced during manufacturing), or a process intermediate, is treated with an antimicrobial to reduce microbial contamination or bioburden (i.e., the number of living microorganisms present). Success of decontamination of a product can be measured by USP <61>, which involves quantitative testing for enumeration of total bacteria, yeast, or mold present.

The term “effective amount” used herein refers to an amount of a preservative composition as disclosed herein that is sufficient to prevent or inhibit microbial growth. The preservative compositions described herein may be active against Gram-positive bacteria, Gram-negative bacteria, yeast, fungi, and/or molds.

The term “elevated pH” refers to a pH value higher than the organic acid is ideally or typically formulated at for product performance (i.e. preservation, cell penetration, or other use). The elevated pH may be at least about 1.5 units higher than the organic acid's pKa in water.

The term “foaming hand soap” refers to a diluted version of liquid hand soap used with specialized dispensers that infuse the solution with air to generate a frothy lather. Inherently, a foaming hand soap is not antimicrobial. The mechanical friction of rubbing the foaming hand soap and rinsing with water is responsible for decreasing the number of microbes on the surface of the skin.

The term “micellar water” refers to an aqueous solution containing a mild detergent that exists in formulation as a dispersion of micelles. This personal care product is intended to be used to remove makeup and other debris from the face. The terms “micellar water” and “micellar cleanser” are used interchangeably herein.

The terms “microorganism” and “microbe” are used interchangeably herein and refer to any living thing that is so small that it can be seen with a microscope, i.e., a microscopic organism. Microbes may exist in a single-celled form or in a colony of cells or in a biofilm. Microbes include eukaryotes and prokaryotes such as bacteria, archaea, protozoa, fungi, algae, amoebas, viruses and the like.

The term “neutral pH” used herein refers to a pH value of about 7.0.

The terms “polyamine” and “polyammonium containing polymer” are used interchangeably and refer to polymers containing primary, secondary, tertiary or quaternary amines in their charged or uncharged state.

The terms “polycationic compounds” and “cationic polymer” are used interchangeably and refer to a polymer having more than one positive charge.

As used herein, the term “polymer” refers to any of a class of natural or synthetic substances composed of repeating chains of molecules. The repeating molecules are multiples of simpler chemical units called monomers. Copolymer refers to two or more chemically different monomers present in the final polymer. When referring to a polymer composed of, comprising, or made from a particular monomer, it is understood that the monomer may undergo changes in chemical composition depending on the synthesis method.

As used herein, “amines” are organic compounds derived from ammonia by replacement of one or more hydrogen atoms by organic groups. Amine compounds and polyamines can exist as primary, secondary, tertiary, and quaternary amines, which refers to the number carbon-nitrogen bonds. Primary amines arise when one of three hydrogen atoms in ammonia is replaced by an alkyl or aromatic group, leaving two hydrogens bound if in the neutral state or three hydrogens if in the protonated state or cationic state. Secondary amines have two organic substituents (alkyl, aryl or both) bound to the nitrogen together with one hydrogen in the neutral state or two hydrogens if in the protonated or cationic state. In tertiary amines, nitrogen has three organic substituents. Quaternary ammoniums have four organic substituents and exists in a cationic charged state. “Ammonium” refers to the charged state of an amine. In the present disclosure, “amine” and “ammonium” may refer to the same compound, depending on its charge state.

The term “preservative” refers to a substance or agent that is added to a product to prevent decomposition or contamination by microbial growth or by undesirable chemical changes. As used herein, preservatives include antimicrobial ingredients added to product formulations to maintain the microbiological safety of the products by inhibiting the growth of and reducing the amount of microbial contaminants. US Pharmacopeia (USP) and the Personal Care Products Counsel (PCPC) have published protocols for acceptable microbial survival for preservatives in cosmetics and personal care products, such as USP <51> (Antimicrobial Effectiveness Test) as well as PCPC M-3. The term “shelf life” refers to the length of time for which an item (e.g., a product as described herein) remains usable, saleable, or fit for consumption.

### Compositions

Disclosed herein are antimicrobial compositions comprising one or more cationic polymers and one or more organic acids, which have biocidal, preservative, antimicrobial, antibacterial, and antiviral (virucidal) activities at an elevated pH. In some embodiments, the antimicrobial composition is effective at a pH at least about 1.5 units higher than the pKa of the organic acid in water. Depending on the organic acid used in the antimicrobial composition, the composition may have antimicrobial effect above pH 5.0, 5.5, 6.0, 6.5, 7.0, 7.5, 8.0, 8.5, or higher. Such an antimicrobial composition may be included in or with (e.g., within or associated with) products to be preserved, e.g., for microbial control. Preservative effectiveness may be evaluated according to USP <51> and PCPC M-3 guidelines, among other standardized testing protocols.

These guidelines provide culture and testing criteria for a variety of microorganisms including bacteria, mold, and yeast, including for example S. aureus (ATCC #6538), P. aeruginosa (ATCC #9027), E. coli (ATCC #8739), C. albicans (ATCC #10231), and A. brasiliensis (ATCC #16404). The compositions disclosed herein may be used in products for personal care, household, industrial, industrial and institutional cleaning, industrial and recreational water, cooling water, food, beverage, pharmaceutical, cosmetic, healthcare, marine, paint, coating, oil, gas, plastic, packaging, textile, agricultural, latex, pulp, and paper products.

In some embodiments, the composition includes the one or more cationic polymers and the one or more organic acids in an amount effective to act as an antimicrobial composition, at an elevated pH. In some embodiments, the antimicrobial composition includes one or more cationic polymers or salts thereof and one or more organic acids or salts thereof in an amount effective to inhibit microbial (e.g., bacterial) growth, resulting in inhibition of up to at least 80%, 85%, 90%, 95%, 98%, 99%, 99.9%, 99.99%, or 99.999% of microbial growth at an elevated pH. In some embodiments, the elevated pH is at least about 1.5 units higher than the organic acid's pKa in water. In additional embodiments, the elevated pH is higher than about 5.5, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.5, 9.0, 9.5, or 10. In certain embodiments, the elevated pH is up to about 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.5, 9.0, 9.5, or 10. In certain embodiments, the elevated pH is between 6.0 and 10.0, between 6.0 and 9.0, between 6.0 and 8.5, between 6.0 and 8.0, between 6.5 and 10.0, between 6.5 and 9.0, between 6.5 and 8.5, or between 6.5 and 8.0. In some embodiments, the organic acid is sodium benzoate.

In some embodiments, the antimicrobial composition comprises one or more cationic polymers or salts thereof and one or more organic acids or salt thereof at a ratio by weight between 1:10 and 1:2,000, between 1:10 and 1:50, between 1:50 and 1:100, between 1:100 and 1:200, between 1:200 and 1:300, between 1:300 and 1:400, between 1:400 and 1:500, between 1:500 and 1:600, between 1:600 and 1:700, between 1:700 and 1:800, between 1:800 and 1:900, between 1:900 and 1:1,000, between 1:1,000 and 1:1,100, between 1:1,100 and 1:1,200, between 1:1,200 and 1:1,300, between 1:1,300 and 1:1,400, between 1:1,400 and 1:1,500, between 1:1,500 and 1:1,600, between 1:1,600 and 1:1,700, between 1:1,700 and 1:1,800, between 1:1,800 and 1:1,900, or between 1:1,900 and 1:2,000. In some embodiments, the cationic polymer or salt thereof and an organic acid or salt thereof are incorporated at a ratio by weight of 1:400 to 1:1,7000. In some embodiments, the cationic polymer or salt thereof and an organic acid or salt thereof are incorporated at a ratio by weight of 1:200, 1:400, 1:800, or 1:1600.

In some embodiments, the antimicrobial composition disclosed herein comprises about 1% sodium benzoate and about 0.0025% by weight cationic polymer(s), or about 0.5% sodium benzoate and about 0.0025% by weight cationic polymer(s) in a final product. In some embodiments, the organic acid is sodium benzoate; and in some embodiments the cationic polymer is a quaternary, tertiary, or secondary polyamine, or a copolymer thereof. In some embodiments, the cationic polymer is a copolymer of quaternary and tertiary amines. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7.

In some embodiments, the antimicrobial composition comprises about 0.1% to about 1% sodium benzoate and about 0.00015% to about 0.0025% by weight dimethylamine-epichlorohydrin copolymer or dimethylamine-epichlorohydrin-ethylenediamine copolymer in a final product. In some embodiments, the sodium benzoate is no more than 0.001%, 0.005%, 0.01%, 0.05%, 0.1%, 0.5%, 1%, 1.5%, 2%, 2.5%, 3%, 3.5%, 4%, 4.5%, or 5% by weight in the final product. In some embodiments, the antimicrobial composition comprising sodium benzoate and one or more cationic polymers disclosed herein has an effective pH range of about 2.5 to about 6.0, and in particular the effective pH is about 2.5, 3.0, 3.5, 4.0, 4.5, 5.0, 5.5 or 6.0. In some embodiments, the antimicrobial composition comprising sodium benzoate and one or more cationic polymers disclosed herein has an effective pH range of at least 6.0, 6.5, 7.0, 7.5, 8.0, 8.5, 9.0, 9.5, or 10. More particularly, the effective pH range is between 6.0 and 10.0, between 6.0 and 9.0, between 6.0 and 8.5, between 6.0 and 8.0, between 6.5 and 10.0, between 6.5 and 9.0, between 6.5 and 8.5, or between 6.5 and 8.0.

### A. Cationic Polymers

As used herein, the term “cationic polymer” references to a specific cationic polymer and salt forms of such polymers. In some embodiments, the cationic polymer in the antimicrobial composition disclosed herein is a cationic ammonium-containing polymer. In some embodiments, the cationic ammonium-containing polymer is a quaternary ammonium-containing polymer, a tertiary ammonium-containing polymer, secondary ammonium-containing polymer, or a primary ammonium-containing polymer, or a combination thereof. In some embodiments, the cationic ammonium-containing polymer is a co-polymer of quaternary ammonium-, a tertiary ammonium-, secondary ammonium-, or a primary ammonium-containing polymer, or a combination thereof.

In some embodiments, the cationic polymer is a polyquaternium. Non-limiting examples of the polyquaternium include Polyquaternium Crosspolymer-2, Polyquaternium Crosspolymer-3, Polyquaternium-1, Polyquaternium-10, Polyquaternium-10/Phosphorylcholine Glycol Acrylate Copolymer, Polyquaternium-100, Polyquaternium-102, Polyquaternium-103, Polyquaternium-104, Polyquaternium-105, Polyquaternium-106, Polyquaternium-107, Polyquaternium-109, Polyquaternium-11, Polyquaternium-110, Polyquaternium-111, Polyquaternium-112, Polyquaternium-113, Polyquaternium-114, Polyquaternium-115, Polyquaternium-116, Polyquaternium-12, Polyquaternium-13, Polyquaternium-14, Polyquaternium-16, Polyquaternium-17, Polyquaternium-18, Polyquaternium-19, Polyquaternium-2, Polyquaternium-20, Polyquaternium-22, Polyquaternium-24, Polyquaternium-27, Polyquaternium-28, Polyquaternium-29, Polyquaternium-30, Polyquaternium-31, Polyquaternium-32, Polyquaternium-33, Polyquaternium-34, Polyquaternium-35, Polyquaternium-36, Polyquaternium-37, Polyquaternium-39, Polyquaternium-4, Polyquaternium-4/Hydroxypropyl Starch Copolymer, Polyquaternium-42, Polyquaternium-43, Polyquaternium-44, Polyquaternium-45, Polyquaternium-46, Polyquaternium-47, Polyquaternium-48, Polyquaternium-49, Polyquaternium-5, Polyquaternium-50, Polyquaternium-51, Polyquaternium-52, Polyquaternium-53, Polyquaternium-54, Polyquaternium-55, Polyquaternium-56, Polyquaternium-57, Polyquaternium-58, Polyquaternium-59, Polyquaternium-6, Polyquaternium-60, Polyquaternium-61, Polyquaternium-62, Polyquaternium-63, Polyquaternium-64, Polyquaternium-65, Polyquaternium-66, Polyquaternium-67, Polyquaternium-68, Polyquaternium-69, Polyquaternium-7, Polyquaternium-70, Polyquaternium-71, Polyquaternium-72, Polyquaternium-73, Polyquaternium-74, Polyquaternium-75, Polyquaternium-76, Polyquaternium-77, Polyquaternium-78, Polyquaternium-79, Polyquaternium-8, Polyquaternium-80, Polyquaternium-81, Polyquaternium-82, Polyquaternium-83, Polyquaternium-84, Polyquaternium-85, Polyquaternium-86, Polyquaternium-87, Polyquaternium-88, Polyquaternium-89, Polyquaternium-9, Polyquaternium-90, Polyquaternium-91, Polyquaternium-92, Polyquaternium-94, Polyquaternium-95, Polyquaternium-96, Polyquaternium-98, Polyquaternium-99, and Sodium Polyquaternium Crosspolymer-1

In certain circumstances, the cationic polymer is prepared from monomers resulting in polyammonium containing polymers with quaternary, tertiary, secondary, or primary ammonium ions or any co-polymer of functionalized amine. Nonlimiting examples of such monomers include diallyl dimethyl ammonium chloride, dimethylamine, ethylenimine, diethylamine, dipropylamine, methanamine, 4-(2-nitrobutyl)morpholine, N-(3-aminopropyl)-N-dodecylpropane-1,3-diamine, glucoprotamine, triethanolamine, lysine, aziridine, acrylamide, vinylpyrrolidone, dimethylamine ethylmethacrylate, acrylic acid, N-butyl methacrylate, dimethylaminopropyl methacrylate, methacryloyl-aminopropyl-lauryldimonium chloride, 2-methacryloyloxyethyl phosphorylcholine, and the like. In some cases, the cationic polymer may be comprised of copolymers of dimethylamine-epichlorohydrin, diethylenetriamine, dimethylaminohydroxypropyl-diethylenetriamine, and the like. Examples of cationic polymers can also be found in WO 2013/124784 A1, EP 0431739 A1, Sun et al. (1981), U.S. Pat. No. 10,563,042 B2, and U.S. Pat. No. 3,975,347 A, which are incorporated by reference in their entirety.

Cationic polymers disclosed herein are capable of extending the pH range at which organic acids have antimicrobial effects (“antimicrobial pH range”). In certain circumstances, the cationic polymer extends the antimicrobial pH range of an organic acid with a pKa lower than 5 (in water) to have antimicrobial effects at an elevated pH. In some embodiments, the organic acid has a pKa of about 2.9 to about 4.9 in water. In some embodiments, the cationic polymer extends the antimicrobial pH range of the organic acid to at least about 1.5 units higher than the organic acid's pKa in water. Depending on the organic acid used, the extended antimicrobial pH range may be above about pH 5.0, 5.5, 6.0, 6.5, 7.0, 7.5, 8.0, 8.5, 9.0, 9.5, or 10. In some embodiments, the cationic polymer is a quaternary, tertiary, or secondary polyamine, or a copolymer thereof. In some embodiments, the cationic polymer is a copolymer of quaternary and tertiary amines. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7, and the organic acid is benzoic acid.

In some embodiments, the average molecular weight of the cationic polymer salts as measured by gel permeation chromatography may range from about 200 g/mol to about 1,000,000 g/mol. In some embodiments, the average molecular weight of the polymer salt may be from about 500 g/mol to about 100,000 g/mol, from about 500 g/mol to about 50,000 g/mol, from about 500 g/mol to about 40,000 g/mol, from about 500 g/mol to about 30,000 g/mol, from about 5,000 g/mol to about 30,000 g/mol, from about 10,000 g/mol to about 30,000 g/mol, from about 500 g/mol to about 20,000 g/mol, from about 500 g/mol to about 10,000 g/mol, from about 50,000 g/mol to 120,000 g/mol, from about 75,000 g/mol to about 110,000 g/mol, or from about 500 gm/mol to about 5,000 g/mol. In some embodiments, the average molecular weight of the cationic polymer salt may be about 100,000 g/mol.

In some embodiments, the antimicrobial composition disclosed herein comprises one or more cationic polymers and one or more organic acids in an effective amount to prevent or decrease growth of one or more microbes in comparison to the identical composition that does not comprise the one or more cationic polymer or salts thereof at an elevated pH. In some embodiments, the elevated pH is at least about 1.5 units higher than the organic acid's pKa in water. In some embodiments, the composition may comprise no more than 0.00015% w/w, 0.00025% w/w, 0.0005% w/w, 0.0075% w/w, 0.001% w/w, 0.00125% w/w, 0.0025% w/w, or 0.005% w/w of the cationic polymer in a final product.

### B. Organic Acids

As used herein, the term “organic acid” or reference to a specific organic acid includes salt forms of such organic acid and includes mixtures of ionized and salt forms. For example, “benzoic acid” shall include the acid form and any conjugate salt form, such as sodium benzoate. Specific salt forms shall include acid forms or salts containing other counter ions. For example, “sodium benzoate” shall include “benzoic acid” and also “potassium benzoate” and other salt forms. In some embodiments, the organic acid in the antimicrobial composition disclosed herein has a pKa lower than 5 in water. In some embodiments, the organic acid has a pKa of about 2.9 to about 4.9 in water. In some embodiments, the organic acid alone has antimicrobial activity at a pH lower than the organic acid's pKa in water and has no or very weak antimicrobial activity at a pH more than 1 unit higher than the organic acid's pKa in water.

Nonlimiting examples of the organic acid in the antimicrobial composition disclosed herein include benzoic acid, lactic acid, propionic acid citric acid, salicylic acid, azelic acid, tannic acid, boric acid, sorbic acid, acetic acid, levulinic acid, ascorbic acid, and caprylic acid and similar fatty acids or derivatives thereof. In some embodiments, the organic acid is benzoic acid. In some embodiments, the salt of the organic acid is sodium benzoate.

In some embodiments, the organic acid or salt thereof is incorporated in the antimicrobial composition disclosed herein in an effective amount to prevent or decrease growth of one or more microbes in comparison to the identical composition that does not comprise the organic acid at a pH higher than 6.0, 6.5. 7.0, 7.5, 8.0, 8.5, 9.0, 9.5, or 10. In some embodiments, the composition may comprise no more than 0.001% w/w, 0.005% w/w, 0.01% w/w, 0.05% w/w, 0.1% w/w, 0.5% w/w, 1% w/w, 1.5% w/w, 2% w/w, 2.5% w/w, 3% w/w, 3.5% w/w, 4% w/w, 4.5% w/w, or 5% w/w of the organic acid in a final product. In particular embodiments benzoic acid or a salt thereof is incorporated into an antimicrobial composition that prevents or decreases growth of one or more microbes at a pH higher than 6.0, 6.5. 7.0, 7.5, 8.0, 8.5, 9.0, 9.5, or 10, and wherein the composition comprises no more than 0.001% w/w, 0.005% w/w, 0.01% w/w, 0.05% w/w, 0.1% w/w, 0.5% w/w, 1% w/w, 1.5% w/w, 2% w/w, 2.5% w/w, 3% w/w, 3.5% w/w, 4% w/w, 4.5% w/w, or 5% w/w of the organic acid in a final product.

In some embodiments, the antimicrobial composition disclosed herein has an enhanced antimicrobial/preservative efficacy compared to a composition comprising the same components except for the cationic polymer(s). In some embodiments, the antimicrobial composition disclosed herein has a similar or enhanced antimicrobial/preservative efficacy compared to a composition comprising the organic acid(s) at a higher concentration(s) and all the other components in the antimicrobial composition disclosed herein except for the cationic polymer(s), wherein the concentration(s) of the organic acid(s) is higher than the composition disclosed herein. In some embodiments, the organic acid is sodium benzoate. In some embodiments, the cationic polymer is a quaternary, tertiary, or secondary polyamine, or a copolymer thereof. In some embodiments, the cationic polymer is a copolymer of quaternary and tertiary amines. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7.

In some embodiments, the organic acid or salt thereof performs a function other than preservation, such as in cosmetic or drug products with anti-inflammation, anti-acne, or anti-dandruff applications, wherein the active ingredient is an organic acid formulated at low pH to maximize absorption into cells or skin. Ascorbic acid, azelaic acid, and other organic acids require formulation at low pH to absorb into skin and deliver the desired effects. Use of these organic acids range from antimicrobial needs such as anti-acne and anti-dandruff to aesthetic needs reducing inflammation or treating hyperpigmentation of the skin, or antioxidant properties. In some products, organic acids are used as corrosion inhibitors or chelators wherein higher pH would be ideal for product performance such as metal binding.

### C. Additional Components

In some embodiments, the antimicrobial composition disclosed herein further comprises one or more antimicrobial enzymes, peptides, and/or proteins, such as a crosslinking enzyme, an oxidase, a nuclease, a hydrolase, a protease, and/or a lytic enzyme. In some embodiments, the composition further comprises one or more additional antimicrobial chemicals, such as, but not limited to, phenoxyethanol, coco betaine, and glycols (e.g. caprylyl glycol, hexanediol, propane diol, ethylhexylglycerin, etc.). In some embodiments, the composition includes both one or more antimicrobial peptides, enzymes and/or proteins and one or more additional antimicrobial chemicals. Nonlimiting examples of known antimicrobial proteins, enzymes, and peptides are shown in Table 1. Nonlimiting examples of antimicrobial chemicals are shown in Table 2. Other miscellaneous antimicrobial chemicals include: iodopropynyl butylcarbamate (IPBC), polyhexamethylene biguanide (PHMB), 1,2-dibromo-2,4-dicyanobutane (DBDCB), and Styrene acrylates.

TABLE 1
Enzymes, Peptides, and Proteins with Known Antimicrobial Properties

| Mechanism | Enzyme | Description | Citation |
|---|---|---|---|
| Lytic | Lysozyme | Produced by animals as | Ibrahim et al. (2001) |
| | | part of the innate immune | FEBS Letters 506(1): 27- |
| | | system. Hydrolyzes the | 32; Małaczewska et al. |
| | | peptidoglycan subunits in | (2019) BMC Vet. Res. |
| | | the bacterial cell wall. | 15: 318 |
| | Chitinase | Secreted by soil bacteria | Martínez-Zavala et al |
| | | including Bacillus | (2020) Front. Microbiol. |
| | | thuringiensis to combat | 10: 3032 |
| | | insects and fungi | |
| | Lipase | Hydrolyzes extracellular | Prabhawathi et al. (2014) |
| | | lipids and polymers. | PloS One 9(5) |
| | Lysin | Utilized by bacteriophages | Hoops et al. (2008) Appl. |
| | | to hydrolyze the glycan | Environ. Microbiol. 75: 5, |
| | | component of bacterial | 1388-1394 |
| | | cell wall | |
| | Lysostaphin | Metalloendopeptidase | Kokai-Kun et al. (2003) |
| | | which cleaves the | Antimicrob Agents |
| | | pentaglycine bridges | Chemother 47(5): 1589- |
| | | found in cell wall | 1597 |
| | | peptidoglycan. | |
| | Glucanase | Secreted by soil bacteria | Shafi et al. (2017) |
| | | including Bacillus species | Biotechnology & |
| | | to degrade the fungal cell | Biotechnological |
| | | wall. Has also been | Equipment 31: 3 446-459 |
| | | utilized as an algicide and | |
| | | for biofilm control. | |
| Nuclease | Dnase | Hydrolyzes extracellular | Kaplan et al. (2012) J. |
| | | nucleic acids and viral | Antibiot. (Tokyo) |
| | | genomic DNA. | 65(2): 73-77 |
| | Rnase | Hydrolyzes viral RNA. | Wirth (1992) |
| | | | WO1994000016A1 |
| | Lactoferrin | Sequesters essential iron | Niaz et al. (2019) |
| | | ions to prevent microbial | International Journal of |
| | | growth. Also possesses | Food Properties 22: 1 |
| | | nuclease activity and | 1626-1641 |
| | | hydrolyzes biofilm | |
| | | polymers. | |
| Oxidoreductase | Glucose Oxidase | Oxidizes glucose to D- | Wong et al. (2008) Appl |
| | | glucono-δ-lactone and | Microbiol Biotechnol. |
| | | hydrogen peroxide. | 78(6): 927-938 |
| | Peroxidase | Oxidizes inert substrates | Ihalin et al. (2006) Arch. |
| | | to form antimicrobial | Biochem. Biophys. 445, |
| | | actives. | 261-268 |
| | Lactoperoxidase | Oxidizes inert substrates | White et al. (1983) |
| | | to form antimicrobial | Antimicrob Agents |
| | | actives. | Chemother 32(2): 267-272 |
| Quorum | Lactonase | Hydrolyzes quorum | Schwab et al. (2019) |
| Quenching | | sensing lactones, | Front Microbiol. 10: 611 |
| | | preventing activation of | |
| | | biofilm- and pathogenesis- | |
| | | promoting pathways. | |
| | Acylase | Hydrolyzes quorum | Vogel et al. (2020) Front. |
| | | sensing lactones, | Chem. 8: 54 |
| | | preventing activation of | |
| | | biofilm- and pathogenesis- | |
| | | promoting pathways. | |
| Hydrolase | Dispersin B | Hydrolyzes biofilm | Izano et al. (2007) J Dent |
| | | polymers | Res 86(7): 618-622 |
| | α-Amylase | Hydrolyzes extracellular | Craigen et al. (2011) Open |
| | | polysaccharides. | Microbiol J. 5: 21-31 |
| | Cellulase | Hydrolyzes the cellulose | Loiselle et al. (2003) |
| | | component of biofilms | Biofouling 19(2): 77-85 |
| | | and algal cell walls. | |
| Cross-Linking | Transglutaminase, | | US 2022/0117236 A1 |
| Enzymes | tyrosinase, and | | |
| | lysyl oxidase | | |
| Antimicrobial | Nisin | Increases permeability of | Li et al. (2018) Appl |
| Peptides | | the microbial cell | Environ Microbiol 18(12) |
| | | membrane. | |
| | Bacteriocin | Modes of action include | Meade et al. (2020) |
| | | inhibition of cell wall | Antibiotics 9(1): 32 |
| | | synthesis and increasing | |
| | | cell membrane | |
| | | permeability. | |
| | Siderophore | Binds to and sequesters | Raaska et al. (1999) J |
| | | iron ions | Indust Microbiol |
| | | | Biotechnol 22, 27-32 |
| | Polymyxin | Increases permeability of | Poirel et al. (2017) Clin |
| | | the microbial cell | Microbiol Rev 30: 577-596 |
| | | membrane. | |
| | Defensin | Increases permeability of | Gans (2003) Nat Rev |
| | | the microbial cell | Immunol 3, 710-720 |
| | | membrane. | |

TABLE 2
Examples of Antimicrobial Chemicals

| Classification | Chemical |
|---|---|
| Polymers | Chitosan |
| | N,N,N-trimethyl chitosan |
| | ε-poly-lysine |
| | Polyvinylbenzyl-dimethylbutyl ammonium chloride |
| | Polyvinylbenzyl trimethyl ammonium chloride |
| | Quaternary ammonium polyethylenimine |
| | Quaternary phosphonium modified epoxidized |
| | natural rubber |
| | Arginine-tryptophan-rich peptide |
| | Guanylated polymethacrylate |
| | Ammonium ethyl methacrylate homopolymers |
| | Metallo-terpyridine carboxymethyl cellulose |
| | Poly(n-vinylimidazole) modified silicone rubber |
| Quaternary | Cocamidopropyl Betaine |
| Ammonium | Myristamidopropyl-pg-dimonium Cl Phosphate |
| | Benzalkonium Chloride (BZK) |
| | Quaternium-6 |
| | Lauryl Betaine |
| | Coco Betaine |
| Detergents | Sodium Lauryl Sulfate |
| | Dodecylbenzenesulfonic Acid |
| Chaotropic | Polyamidopropyl biguanide |
| Agent | Guanidinium chloride |
| Phenols, | Ethanol |
| Alcohols, & | Isopropanol |
| Polyols | Dichlorobenzyl Alcohol |
| | Glycerol |
| | Caprylyl Glycol |
| | Ethylhexylglycerin |
| | 1,3-Propanediol |
| | 1,2-Hexanediol and 1,6-Hexanediol |
| | 1,2-Pentanediol |
| | 1,10-Decanediol |
| | 2,3-Butanediol |
| | Phenylpropanol |
| | Caprylyl glyceryl ether |
| | Gluconolactone |
| | Hydroxyacetophenone |
| | Benzyl Alcohol |
| | Phenethyl alcohol |
| | p-Anisic acid |
| | 2-Phenoxyethanol |
| Aldehydes & | Glutaraldehyde |
| Aldehyde | Formaldehyde and Formaldehyde releasers |
| Releasers | Sodium Hydroxymethylglycerate |
| | DMDM Hydantoin |
| Base | Sodium Hydroxide |
| Oxidizers | Hydrogen Peroxide and Peracids (peracetic acid) |
| Chelators | Ethylenediaminetetracetic acid (EDTA) |
| | tetrasodium glutamate diacetate (GLDA) |
| | methylglycine N,N-diacetic acid (MDGA) |
| Parabens | Methyl Paraben |
| | Ethyl Paraben |
| | Propyl Paraben |
| Miscellaneous | Natamycin |
| | Benzisothiazolinone (BIT) |
| | Bronopol |
| | Sorbitan Caprylate |
| | Ethyl Lauroyl Arginate |
| | Methylisothiazolinone (MIT) |
| | Cetylpyridinium Chloride |
| | Chlorphenesin |
| | Zinc Omadine |
| | Sodium Omadine |
| | N-(3-aminopropyl)-N-dodecylpropane-1,3-diamine |
| | Methylchloroisothiazolinone |
| | 2,2-dibromo-3-nitrilopropionamide |
| | 1-Octadecanaminium, N,N-dimethyl-N-[3- |
| | (trimethoxysilyl)propyl]-,chloride |
| | Saponin |
| | Ethyl lauroyl arginate |
| | Capryl hydroxamic acid (CHA) |

### Products and Uses

The compositions described herein can be used to inhibit microbial growth in many types of products. In some cases, the antimicrobial compositions can act as a preservative or extend the shelf life of such products. In some embodiments, products disclosed herein include personal care products, household products, industrial, industrial and institutional cleaning, industrial and recreational water, cooling water, food, beverages, pharmaceutical, cosmetic, healthcare, marine, paints, coatings, adhesives, oil, gas, plastic, packaging, textiles, agricultural, latex, pulp, or paper products, which include an effective amount of an antimicrobial composition as described herein, to act as an antimicrobial agent, e.g., preservative, in the product. In some embodiments the compositions described herein can function as corrosion inhibitors, oxidation inhibitors, chelators, or skin and cell penetration of acids for hyperpigmentation.

In some embodiments, product comprising the antimicrobial composition disclosed herein has a pH value of about 5.0, 5.5, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.5, 9.0, 9.5, or 10. In some embodiments, the products has a pH value of at least 5.0, 5.5, 6.0, 6.1, 6.2, 6.3, 6.4, 6.5, 7.0, 7.1, 7.2, 7.3, 7.4, 7.5, 7.6, 7.7, 7.8, 7.9, 8.0, 8.5, 9.0, 9.5, or 10. In some embodiments, the products has a pH value between 6.0 and 10, between 6.0 and 9.0, between 6.0 and 8.5, between 6.0 and 8.0, between 6.5 and 10, between 6.5 and 9.0, between 6.5 and 8.5, or between 6.5 and 8.0.

In some embodiments, a product may comprise no more than 0.001% w/w, 0.005% w/w, 0.01% w/w, 0.05% w/w, 0.1% w/w, 0.5% w/w, 1% w/w, 1.5% w/w, 2% w/w, 2.5% w/w, 3% w/w, 3.5% w/w, 4% w/w, 4.5% w/w, or 5% w/w of the organic acid and at least 0.00015% w/w, 0.00025% w/w, 0.0005% w/w, 0.0075% w/w, 0.001% w/w, 0.00125% w/w, 0.0025% w/w, or 0.005% w/w of the cationic polymer. In some embodiments, a product may comprise about 0.001% w/w, 0.005% w/w, 0.01% w/w, 0.05% w/w, 0.1% w/w, 0.5% w/w, 1% w/w, 1.5% w/w, 2% w/w, 2.5% w/w, 3% w/w, 3.5% w/w, 4% w/w, 4.5% w/w, or 5% w/w of the organic acid and about 0.00015%, 0.00025% w/w, 0.0005% w/w, 0.0075% w/w, 0.001% w/w, 0.00125% w/w, 0.0025% w/w, or 0.005% w/w of the cationic polymer. In some embodiments, the organic acid is sodium benzoate. In some embodiments, the cationic polymer is a quaternary, tertiary, or secondary polyamine, or a copolymer thereof. In some embodiments, the cationic polymer is a copolymer of quaternary and tertiary amines. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7. In some embodiments, the product comprises about 1% sodium benzoate and about 0.0025% by weight cationic polymer(s), or about 0.5% sodium benzoate and about 0.0025% by weight cationic polymer(s). In some embodiments, the product comprises about 0.1% to about 1% sodium benzoate and about 0.00015% to about 0.0025% by weight of a linear polyethylenimine, a branched polyethylenimine, a dimethylamine-epichlorohydrin copolymer, a dimethylamine-epichlorohydrin-ethylenediamine copolymer, or polyquaternium-7.

In some embodiments, products disclosed herein include cosmetics and personal care products, which include the antimicrobial compositions described herein, and one or more active or functional ingredients such as a sunscreen and/or color producing molecule. In some embodiments, the product may comprise an antimicrobial composition in an amount of about 0.001% w/w, 0.005% w/w, 0.01% w/w, 0.05% w/w, 0.1% w/w, 0.5% w/w, 1% w/w, 1.5% w/w, 2% w/w, 2.5% w/w, 3% w/w, 3.5% w/w, 4% w/w, 4.5% w/w, or 5% w/w of the organic acid and about 0.00015% w/w, 0.00025% w/w, 0.0005% w/w, 0.0075% w/w, 0.001% w/w, 0.00125% w/w, 0.0025% w/w, or 0.005% w/w of the cationic polymer. In some embodiments, the organic acid is sodium benzoate. In some embodiments, the cationic polymer is a linear polyethylenimine, a branched polyethylenimine, a dimethylamine-epichlorohydrin copolymer, a dimethylamine-epichlorohydrin-ethylenediamine copolymer, or polyquaternium-7.

In some embodiments, an antimicrobial composition is included in a personal care product, such as, but not limited to, bar soap, liquid or hand soap, hand sanitizer (including rinse off and leave-on alcohol based and aqueous-based hand disinfectants), preoperative skin disinfectant, cleansing wipes, disinfecting wipes, body wash, acne treatment products, diaper rash cream, skin cream, shampoo, anti-dandruff shampoo, conditioner, cosmetics (including but not limited to liquid or powder foundation, liquid or solid eyeliner, mascara, cream eye shadow, tinted powder, “pancake” type powder to be used dry or moistened, make up removal products, etc.), deodorant, antimicrobial creams, body lotion, hand cream, topical cream, aftershave lotion, skin toner, mouth wash, toothpaste, sunscreen lotion, and baby products such as, but not limited to, cleansing wipes, baby shampoo, baby soap, and diaper cream. In some embodiments, the antimicrobial composition is included in a wound care item, such as, but not limited to, wound healing ointments, creams, and lotions, wound coverings, burn wound cream, bandages, tape, and steri-strips. In some embodiments, the antimicrobial composition is included in an oral care product, such as mouth rinse, toothpaste, or dental floss coating, a veterinary or pet care product, a preservative composition, or a surface disinfectant, such as a disinfectant solution, spray, or wipe.

In some embodiments, the antimicrobial composition is in a product, such as a personal care, household, industrial, industrial and institutional cleaning, industrial and recreational water, cooling water, food, beverage, pharmaceutical, cosmetic, healthcare, marine, paint, coating, adhesive, oil, gas, plastic, textile, packaging, agricultural, latex, pulp, or paper product, or in any of the products or systems disclosed herein, microbial growth is decreased, the product is preserved, and/or shelf life of the product is increased in comparison to an identical product that does not contain the antimicrobial composition.

In some embodiments, the product disclosed herein is a product having a pH of about 7.0, 6.5, 6.0, 5.5, 5.0, 4.5, 4.0, or lower and comprises the antimicrobial composition in an amount of about 0.001%, 0.005%, 0.01%, 0.05%, or 0.1% by weight of the organic acid and about 0.00015%, 0.00025%, 0.0005%, 0.0075%, or 0.001% by weight of the cationic polymer. In some embodiments, the product has a pH of about 7.0 or lower, comprises the antimicrobial composition in an amount of about 0.5%, 0.4%, 0.3%, 0.2%, or 0.1% by weight or less of the organic acid, and has improved preservative or antimicrobial activity compared to an identical product that does not contain the cationic polymer. Non-limiting examples of products having a pH of about 7.0 or less include food or beverage products such as fruit juice, carbonated soft drink beverage, jams, sauces, or personal care products. In some embodiments, the organic acid is sodium benzoate. In some embodiments, the cationic polymer is a quaternary, tertiary, or secondary polyamine, or a copolymer thereof. In some embodiments, the cationic polymer is a copolymer of quaternary and tertiary amines. In additional embodiments, the cationic polymer is selected from a linear polyethylenimine, a branched polyethylenimine, a dimethylamine-epichlorohydrin copolymer, a dimethylamine-epichlorohydrin-ethylenediamine copolymer, or polyquaternium-7.

In some embodiments, products comprising an effective amount of an antimicrobial composition disclosed herein has a prolonged shelf life compared to identical products comprising all components of the antimicrobial composition disclosed herein except for the cationic polymer(s). In some embodiments, products comprising an effective amount of an antimicrobial composition disclosed herein have reduced microbial growth compared to identical products that do not contain a cationic polymer as disclosed herein. In some embodiments, products comprising an34thylenede amount of an antimicrobial composition disclosed herein have improved ability to withstand microbial challenges compared to identical products that do not contain a cationic polymer as disclosed herein. In some embodiments, the products comprising an effective amount of the antimicrobial composition disclosed herein has a similar or prolonged shelf life compared to identical products comprising the organic acid(s) at a higher concentration(s) and all the other components of the antimicrobial composition disclosed herein except for the cationic polymer(s).

In some embodiments, a method for increasing the shelf life, integrity, or microbial free (e.g., bacterial and/or fungal free) status of a product composition, or preserving a product composition, such as a personal care, household or industrial product is provided, wherein the method includes incorporating an effective amount of an antimicrobial composition as disclosed herein into the product. In some embodiments, the effective amount may be an amount, referred to as the MIC (minimum inhibitory concentration), which results in reduction of microbial growth by approximately 80-100%, or any of at least about 80%, 85%, 90%, 95%, 98%, 99%, 99.9%, 99.99%, or 99.999% reduction of microbial growth as described herein.

In some embodiments, an antimicrobial composition as disclosed herein is included in any of the products disclosed herein at a concentration of about 0.001% w/w, 0.005% w/w, 0.01% w/w, 0.05% w/w, 0.1% w/w, 0.5% w/w, 1% w/v, 1.5% w/w, 2% w/w, 2.5% w/w, 3% w/v, 3.5% w/w, 4% w/w, 4.5% w/w, or 5% w/w of the organic acid and about 0.00015% w/w, 0.00025% w/w, 0.0005% w/w, 0.0075% w/w, 0.001% w/w, 0.00125% w/w, 0.0025% w/w, or 0.005% w/w of the cationic polymer.

Non-limiting examples of household/industrial products containing the disclosed antimicrobial compositions include householder cleaners such as concentrated liquid cleaners and spray cleaners, cleaning wipes, dish washer detergent, dish soap, spray-mop liquid, furniture polish, indoor paint, outdoor paint, dusting spray, laundry detergent, fabric softener, rug/fabric cleaner, window and glass cleaner, toilet bowl cleaner, liquid/cream cleanser, etc. used in a food wash product, designed to clean fruits and vegetables prior to consumption, packaging, and food coatings.

### EXAMPLES

The following examples are intended to illustrate, but not limit, the invention. Accordingly, from the above discussion and the Examples, one skilled in the art can ascertain essential characteristics of this disclosure, and without departing from the spirit and scope thereof, can make various changes and modifications to adapt to various uses and conditions.

Unless defined otherwise herein, all technical and scientific terms used herein have the same meaning as commonly understood by one of ordinary skill in the art to which this disclosure belongs.

Microbial strains used in the examples disclosed herein and their corresponding ATCC nos. are as follows: E. coli (ATCC #8739), S. aureus (ATCC #6538), P. aeruginosa (ATCC #9027), C. albicans (ATCC #10231), and A. brasiliensis (ATCC #16404). Sodium benzoate (USP grade) was obtained from AD Distribution. Microbial strains and sterile peptone buffer were acquired from NSI Lab Solutions (Raleigh, NC) and the microbes were maintained frozen at −20° C. as dehydrated cell stocks until use. Butterfield's phosphate dilution buffer (BPDB) was acquired from Remel (Lenexa, KS). Tryptic soy agar plus polysorbate 80 plus lecithin petri dishes, and Sabouraud dextrose agar petri dishes were obtained from Smith River Biologicals (Ferrum, VA).

Cationic polymers are summarized in table 3. Polyquaternium-7 (8.5-9.5% solids in water), linear polyethylenimine (linear PEI; 50% solids in water), branched polyethylenimine (branched PEI; neat, viscous liquid, <1% water) and ε-polylysine (solid) were sourced from Tri-K, MP Biomedicals, Sigma-Aldrich, and MarkNature, respectively. Polyammonium containing polymers that are copolymers of dimethylamine and epichlororhydrin and polyammonium containing polymers that are copolymers of dimethylamine, epichlororhydrin, and ethylenediamine were sourced from Alfa Chemical, Kemira, Buckman, BOC Sciences, Shanghai Sunwise Chemical Co., and Parchem as 48-52% solids in water and performed similarly in testing.

The concentration of each polymer is reported as the percent active (solids or polymer) in solution by weight. For example, a sample containing 0.0025% polymer no. 1 contains 0.0025% polymer by weight.

TABLE 3
Cationic polymers

| Polymer | Common or Trade | | Molecular | |
|---|---|---|---|---|
| No. | Name | Monomers | Weight | CAS # |
| 1 | Superfloc ® C-569 | | Medium | |
| 2 | Dimethylamine- | Dimethylamine- | Low | 25988-97-0 |
| | epichlorohydrin | epichlorohydrin | | |
| | copolymer | copolymer | | |
| 3 | Dimethylamine/ | Dimethylamine- | Low | 42751-79-1 |
| | Ethylenediamine/ | epichlorohydrin- | | |
| | Epichlorohydrin | ethylenediamine | | |
| | Copolymer | copolymer | | |
| 4 | Dimethylamine/ | Dimethylamine- | Medium | 42751-79-1 |
| | Ethylenediamine/ | epichlorohydrin- | (~100,000 | |
| | Epichlorohydrin | ethylenediamine | g/mol) | |
| | Copolymer | copolymer | | |
| 5 | Dimethylamine/ | Dimethylamine- | High | 42751-79-1 |
| | Ethylenediamine/ | epichlorohydrin- | | |
| | Epichlorohydrin | ethylenediamine | | |
| | Copolymer | copolymer | | |
| 6 | Linear | Substituted aziridine | low | 9002-98-6 |
| | Polyethylenimine | or 2-oxazolines | | |
| 7 | Branched | Aziridine | low | 9002-98-6 |
| | Polyethylenimine | | | |
| 8 | Polyquaternium-7 | Acrylamide, diallyl | low | 26590-05-6 |
| | | dimethylammonium chloride | | |
| 9 | ε-Polylysine | Lysine | low | 28211-04-3 |

### Formulation Examples

TABLE 4
Foaming hand soap

| | % composition | |
|---|---|---|
| Ingredient | (w/w) | Purpose |
| Water | Q.S. to 100% | Carrier |
| Suga ®Boost 050 | 15% | Surfactant |
| Polysorbate 20 | 0.2% | Nonionic Surfactant |
| D-Panthenol (50% liquid) | 0.3% | Humectant |
| Glycerin | 2% | Humectant |
| Preservative | Varies | Preservative |

TABLE 5
Micellar Cleanser

| | % composition | |
|---|---|---|
| Ingredient | (w/w) | Purpose |
| Water | Q.S. to 100% | Carrier |
| Methyl Gluceth-20 | 1% | Humectant |
| D-Panthenol | 0.25% | Humectant |
| Coconut Oil Glycereth-8 Esters | 1.2% | Emulsifying Agent |
| Preservative | Varies | Preservative |

TABLE 6
Hair Conditioner

| | % composition | |
|---|---|---|
| Ingredient | (w/w) | Purpose |
| Water | Q.S. to 100% | Carrier |
| Cetearyl Alcohol | 5% | Emollient |
| Linoleamidopropyl PG-Dimonium | 5% | Surfactant |
| Chloride Phosphate | | |
| Hydroxypropyl Bis- | 1% | Humectant |
| Hydroxyethyldimonium Chloride | | |
| Phenyl Trimethicone | 1.5% | Conditioning Agent |
| Preservative | Varies | Preservative |

TABLE 7
Body Lotion

| | % composition | |
|---|---|---|
| Ingredient | (w/w) | Purpose |
| Water | Q.S. to 100% | Carrier |
| Glycerin | 2% | Humectant |
| Xanthan Gum | 0.2% | Thickener |
| Cetearyl Glucoside, | 1% | Emulsifier |
| Cetearyl Alcohol | | |
| Cetearyl Alcohol | 1.5% | Emollient |
| Preservative | Varies | Preservative |

TABLE 8
Body Wash

| | % composition | |
|---|---|---|
| Ingredient | (w/w) | Purpose |
| Water | Q.S. to 100% | Carrier |
| Glycerin | 3% | Humectant |
| Sodium Lauryl | 5% | Cleansing Agent |
| Sulfoacetate | | |
| Water, Cocamidopropyl | 1% | Viscosity |
| Hydroxysultaine, Sodium | | Controller |
| Chloride | | |
| Coco-Glucoside (and) | 1.5% | Emulsifying |
| Glyceryl Oleate | | Surfactant |
| Preservative | Varies | Preservative |

TABLE 9
Household Cleaner

| | % composition | |
|---|---|---|
| Ingredient | (w/w) | Purpose |
| Water | Q.S. to 100% | Carrier |
| Functionalized Alkyl | 5% | Nonionic Surfactant |
| Polyglucosides | | |
| Preservative | Varies | Preservative |

TABLE 10
Laundry Detergent

| | % composition | |
|---|---|---|
| Ingredient | (w/w) | Purpose |
| Water | Q.S. to 100% | Carrier |
| Sodium Hydroxide | 1% | Buffer |
| Sodium Laureth Sulfate | 15% | Anionic Surfactant |
| (SLES) | | |
| Functionalized Alkyl | 3.00% | Nonionic Surfactant |
| Polyglucosides | | |
| Sodium Citrate | 1% | Builder |
| Sodium Polyacrylate | 0.1-5% | Anti-Redeposition |
| | | Agent |
| Amylase | 0.5% | Enzyme |
| Cellulase | 0.5% | Enzyme |
| Preservative | Varies | Preservative |

TABLE 11
Dish Soap

| | % composition | |
|---|---|---|
| Ingredient | (w/w) | Purpose |
| Water | Q.S. to 100% | Carrier |
| Potassium Cocoate | 35% | Anionic Surfactant |
| Cocamidopropyl | 10% | Amphoteric Surfactant |
| Hydroxysultaine | | |
| Sodium Cocoyl Isethionate | 5% | Anionic Surfactant |
| Sodium Chloride | Q.S. | Viscosity Modifier |
| Preservative | Varies | Preservative |

TABLE 12
Paint

| | | |
|---|---|---|
| Ingredient | % composition (w/w) | Purpose |

Grind

| | | |
|---|---|---|
| Water | 10.1% | Solvent |
| Tamol 851 | 0.9% | Dispersant |
| Byk 28 | 0.2% | Defoamer |
| Kronos TiO2 | 45.9% | Pigment |

Letdown

| | | |
|---|---|---|
| Water | 4.9% | Solvent |
| Raycryl 1207 | 31.1% | Emulsion Binder |
| Coalescent | 0.9% | Coalescent |
| Natrosol HBR | 0.2% | Rheology Modifier |
| Preservative | varies | Preservative |

### Example 1. Preparation of Foaming Hand Soap for Challenge Testing

The foaming hand soap used in the examples disclosed herein was prepared according to the formulation in Table 4 as follows. A vessel was filled with deionized water, placed under an overhead stirrer set to a moderate mixing speed, and heated to 65-75° C. Suga®Boost 050 (functionalized alkyl polyglucoside), polysorbate 20, D-panthenol (50% liquid), and glycerin were sequentially added to the deionized water. The batch of foaming hand soap was split into portions and allowed to cool. pH was measured and adjusted to 6.0-8.5 using citric acid or sodium hydroxide as needed. Each portion of the batch was sterilized by filtering with a 0.22-μm filter. For the challenge testing, different potions of the foaming hand soap were either untreated (unpreserved) or treated with the compositions under test as disclosed herein.

### Example 2. Antimicrobial Challenge Testing Procedures

The antimicrobial challenge testing disclosed herein include antimicrobial challenge testing, antifungal challenge testing, and confirmatory antimicrobial challenge testing.

### A. Antimicrobial Challenge Testing and Antifungal Challenge Testing

For antibacterial challenge testing, one vial each of E. coli, S. aureus, and P. aeruginosa was rehydrated in 1 mL peptone buffer. The concentrations of the cell suspensions were determined based on the Certificates of Analysis accompanying each bacteria vial, and the suspensions were combined and diluted in BPDB to make a 3×10⁸ CFU/mL bacterial pool composed of 1×10⁸ CFU/mL of each of E. coli, S. aureus, and P. aeruginosa at a final volume of 1 mL. For antifungal challenge testing, one vial of C. albicans was rehydrated in 1 mL peptone buffer. The concentration of the cell suspension was determined based on the Certificate of Analysis accompanying the vial of yeast. The resuspended cells were diluted in BPDB to 3×10⁷ CFU/mL at a final volume of 1 mL.

The enumeration of the microbial population in antibacterial and antifungal challenge testing was performed in the following manner. At day 0, a 3-mL sample was collected from each of the prepared formulations and inoculated with 0.03 mL of the bacterial pool to obtain a final inoculum of 3×10⁶ CFU/mL. The inoculated samples were maintained under the same conditions from day 0 to day 7. At each analysis timepoint, the inoculated samples were subjected to 10-fold serial dilutions in BPDB to obtain diluted samples such that 25-250 colonies were estimated to be yielded from 0.1 mL of the diluted sample plated on a tryptic soy agar petri dish containing Polysorbate 80 and Lecithin. The petri dishes were incubated at 31.5+/−1° C. for 24 to 48 hours. The petri dishes were then removed from the incubator and the colonies were counted and multiplied by their corresponding dilution factors to determine the bacterial concentrations (in CFU/mL) of the samples. At day 2 and day 7 post-inoculation, the serial dilutions, plating, and colony counting were repeated to monitor the changes in bacterial population. The antimicrobial efficacies of each treatment were calculated as log reductions in CFU/mL at different timepoints (e.g., day 2 and day 7) compared to day 0 respectively.

### B. Confirmatory Antimicrobial Challenge Testing

Confirmatory antimicrobial challenge testing performed by an external certified testing facility used a modified version of PCPC M-3 with variable timepoints. E. coli, S. aureus, and P. aeruginosa were grown separately in tryptic soy broth for 18-24 hours. A. brasiliensis was grown on Sabouraud dextrose agar for 7-10 days. C. albicans was grown on potato dextrose agar for 48+/−4 hours. The target inoculum for E. coli, S. aureus, and P. aeruginosa was greater than 1×10⁶ CFU/mL. The target inoculum for both A. brasiliensis and C. albicans was between 1×10⁵ CFU/mL and 1×10⁶ CFU/mL.

A modified version of PCPC M-3 with variable timepoints to enumerate the microbial population was performed in the following manner. At day 0, 10 mL samples were collected from each of the treated formulation samples and inoculated with 0.05 mL of each organism, respectively (E. coli (ATCC #8739), S. aureus (ATCC #6538), P. aeruginosa (ATCC #9027), A. brasiliensis (ATCC #16404), and C. albicans (ATCC #10231)) to obtain a final inoculum of greater than 1×10⁶ CFU/mL for bacteria and between 1×10⁵ CFU/mL and 1×10⁶ CFU/mL for fungi. At each analysis time point, 0.01 mL of the samples inoculated with bacteria was plated on a tryptic soy agar and nutrient agar petri dish, while the samples inoculated with fungi were plated on potato dextrose agar. The inoculated samples derived from all portions were maintained under the same condition for every timepoint. The petri dishes with bacteria were incubated at 36.0+/−1° C. for 24 to 48 hours. The petri dishes with fungi were incubated at 30.0+/−2° C. The petri dishes were removed from the incubator and the colonies were counted and multiplied by their corresponding dilution factors to determine the microbial concentrations (in CFU/mL) of the samples. The antimicrobial efficacies of each treatment were calculated as log reductions in CFU/mL at different timepoints (e.g., day 2, day 7, day 14, and day 28) compared to day 0 respectively.

### Example 3. Antibacterial Challenge Testing of Foaming Hand Soap

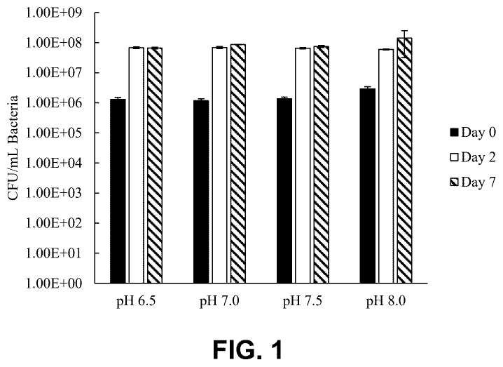

Using the method described in Example 2A, antibacterial challenge testing was performed with untreated foaming hand soap portions adjusted to pH values of 6.5, 7.0, 7.5, or 8.0. Viable bacterial cell counts in unpreserved foaming hand soap portions are reported in FIG. 1. Antibacterial challenge testing results of unpreserved foaming hand soap at different pH values are shown in Table 13. No reduction in viable bacterial cell counts was observed in unpreserved foaming hand soap at any of the pH values tested.

TABLE 13
Antibacterial challenge testing of unpreserved foaming
hand soap against bacteria at pH 6.5, 7.0, 7.5 or 8.0

| Sample | pH | Day 2* | Day 7* |
|---|---|---|---|
| Unpreserved | 6.5 | −1.72 | −1.71 |
| Unpreserved | 7.0 | −1.77 | −1.87 |
| Unpreserved | 7.5 | −1.68 | −1.74 |
| Unpreserved | 8.0 | −1.31 | −1.69 |

*Log reduction in CFU/mL compared to Day 0, negative number indicates log increase in CFU/mL (i.e., cell growth).

### Example 4. Antibacterial Challenge Testing of Foaming Hand Soap Treated with Sodium Benzoate

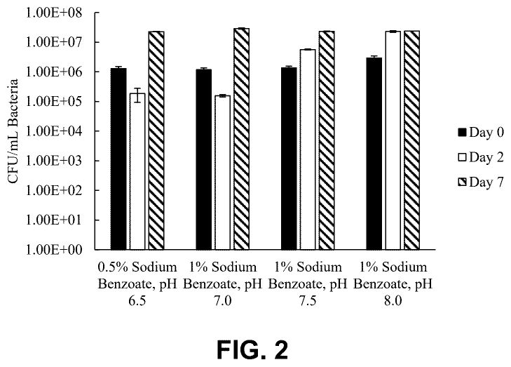

Using the method described in Example 2A, antibacterial challenge testing was performed with foaming hand soap portions adjusted to pH values of 6.5, 7.0, 7.5, or 8.0 and treated with sodium benzoate. Viable bacterial cell counts in different foaming hand soap potions are reported in FIG. 2. The preservative efficacy of sodium benzoate at each pH value is shown in Table 14. Modest reductions in CFU/mL were observed in sodium benzoate-treated foaming hand soap at pH 6.5 and pH 7.0 by day 2. By day 7, no reduction in CFU/mL was observed in any of the sodium benzoate-treated foaming hand soap portions tested.

TABLE 14
Antibacterial challenge testing of sodium benzoate against
bacteria in foaming hand soap at pH 6.5, 7.0, 7.5, or 8.0

| Sample (dosage) | pH | Day 2* | Day 7* |
|---|---|---|---|
| Sodium Benzoate (0.5%) | 6.5 | 0.84 | −1.25 |
| Sodium Benzoate (1%) | 7.0 | 0.88 | −1.39 |
| Sodium Benzoate (1%) | 7.5 | −0.62 | −1.23 |
| Sodium Benzoate (1%) | 8.0 | −0.90 | −0.91 |

*Log reduction in CFU/mL compared to Day 0, negative number indicates log increase in CFU/mL (i.e., cell growth).

### Example 5. Antimicrobial Challenge Testing of Foaming Hand Soap Treated with Cationic Polymers

### A. Antimicrobial Challenge Testing of Foaming Hand Soap at pH 7.0

Using the method described in Example 2A, antibacterial challenge testing was performed with foaming hand soap portions (pH 7.0) treated with one of polymer nos. 1-9 at a final concentration ranging from 0.000625% to 0.09% w/w.

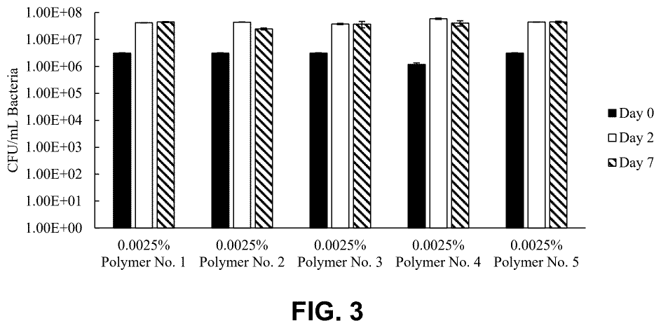

Viable bacterial cell counts in different foaming hand soap portions treated with polymer nos. 1-5 are reported in FIG. 3. The preservative efficacies of polymer nos. 1-5 at 0.0025% are shown in Table 15. No reduction in bacterial CFU/mL was observed in any of the foaming hand soap portions treated with polymer nos. 1-5 at pH 7.

TABLE 15
Preservative efficacy of polymer nos. 1-5 against
bacteria in foaming hand soap at pH 7.0

| Sample (dosage) | Day 2* | Day 7* |
|---|---|---|
| Polymer No. 1 (0.0025%) | −1.13 | −1.16 |
| Polymer No. 2 (0.0025%) | −1.15 | −0.90 |
| Polymer No. 3 (0.0025%) | −1.08 | −1.08 |
| Polymer No. 4 (0.0025%) | −1.70 | −1.54 |
| Polymer No. 5 (0.0025%) | −1.16 | −1.16 |

*Log reduction in CFU/mL compared to Day 0, negative number indicates log increase in CFU/mL (i.e., cell growth).

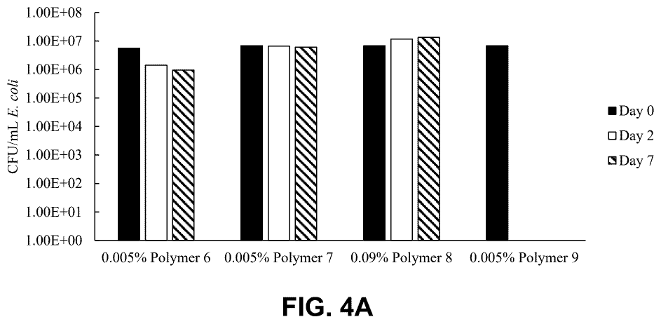

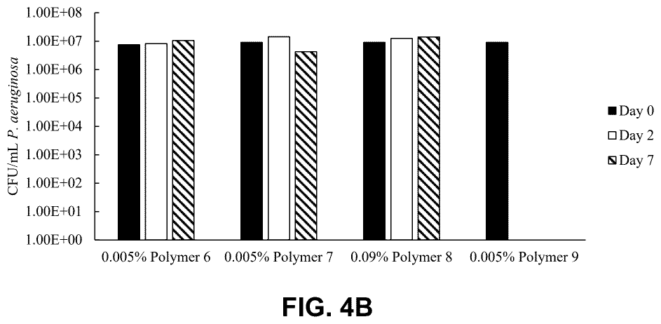

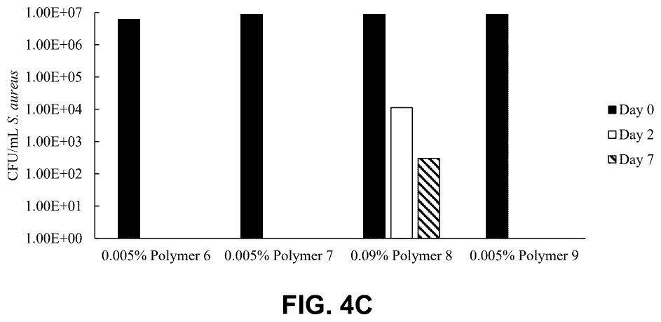

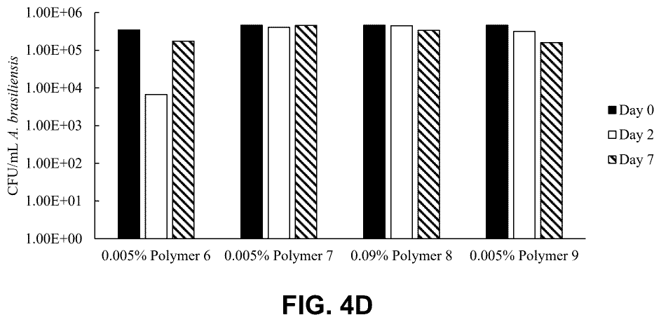

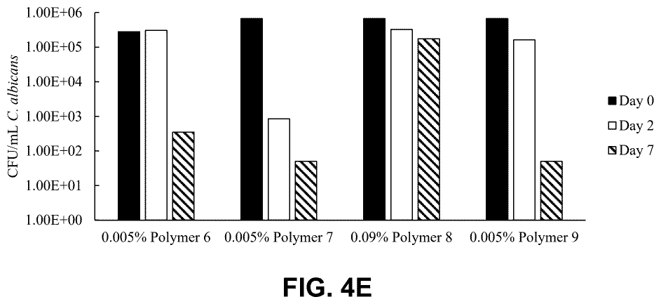

Using the method described in Example 2B, antimicrobial challenge testing was performed with foaming hand soap (pH 7.0) treated with one of polymer nos. 6-9 at a final concentration of 0.005% or 0.09% w/w. Viable microbial cell counts in different foaming hand soap portions treated with polymer nos. 6-9 are reported in FIGS. 4A-E. The preservative efficacies of polymer nos. 6-9 are shown in Tables 16A-E. Of the polymers tested, only polymer no. 9 achieved about a 7-log reduction in CFU/mL for all bacterial strains. Both polymer no. 6 and polymer no. 7 achieved about a 7-log reduction in CFU/mL for S. aureus, while polymer no. 8 achieved a more modest reduction of about 4-log in CFU/mL by Day 7 for S. aureus.

### Tables 16A-E. Preservative Efficacies of Polymer Nos. 6-9 Against 5 Challenge Microorganisms in Foaming Hand Soap at pH 7.0

TABLE 16A
E. coli

| Sample (dosage) | Day 2* | Day 7* |
|---|---|---|
| Polymer No. 6 (0.005%) | 0.60 | 0.77 |
| Polymer No. 7 (0.005%) | 0.02 | 0.05 |
| Polymer No. 8 (0.09%) | −0.23 | −0.29 |
| Polymer No. 9 (0.005%) | 6.84 | 6.84 |

TABLE 16B
P. aeruginosa

| Sample (dosage) | Day 2* | Day 7* |
|---|---|---|
| Polymer No. 6 (0.005%) | −0.04 | −0.15 |
| Polymer No. 7 (0.005%) | −0.20 | 0.33 |
| Polymer No. 8 (0.09%) | −0.14 | −0.19 |
| Polymer No. 9 (0.005%) | 6.95 | 6.95 |

TABLE 16C
S. aureus

| Sample (dosage) | Day 2* | Day 7* |
|---|---|---|
| Polymer No. 6 (0.005%) | 6.78 | 6.78 |
| Polymer No. 7 (0.005%) | 6.94 | 6.94 |
| Polymer No. 8 (0.09%) | 2.89 | 4.46 |
| Polymer No. 9 (0.005%) | 6.94 | 6.94 |

TABLE 16D
A. brasiliensis

| Sample (dosage) | Day 2 | Day 7 |
|---|---|---|
| Polymer No. 6 (0.005%) | 1.71 | 0.29 |
| Polymer No. 7 (0.005%) | 0.06 | 0.00 |
| Polymer No. 8 (0.09%) | 0.01 | 0.13 |
| Polymer No. 9 (0.005%) | 0.16 | 0.46 |

TABLE 16E
C. albicans

| Sample (dosage) | Day 2* | Day 7* |
|---|---|---|
| Polymer No. 6 (0.005%) | −0.04 | 2.90 |
| Polymer No. 7 (0.005%) | 2.90 | 4.13 |
| Polymer No. 8 (0.09%) | 0.31 | 0.58 |
| Polymer No. 9 (0.005%) | 0.62 | 4.13 |

*Log reduction in CFU/mL compared to Day 0, negative number indicates log increase in CFU/mL (i.e., cell growth).

### B. Antibacterial Challenge Testing of Foaming Hand Soap at pH 6.5, 7.0, or 7.5

Using the method described in Example 2A, antibacterial challenge testing was performed with foaming hand soap portions adjusted to pH 6.5, 7.0, or 7.5 and treated with at least one of the cationic polymers from polymer nos. 1-9. The preservative efficacy of polymer no. 4 is shown in Table 17. Polymer no. 4 caused no reduction in CFU/mL at each pH value tested at day 7.

TABLE 17
Preservative efficacy of polymer no. 4 alone against
bacteria in foaming hand soap at pH 6.5, 7.0, or 7.5

| Sample (dosage) | pH | Day 2* | Day 7* |
|---|---|---|---|
| Polymer No. 4 (0.0025%) | 6.5 | 2.11 | −0.67 |
| Polymer No. 4 (0.0025%) | 7.0 | −1.70 | −1.54 |
| Polymer No. 4 (0.0025%) | 7.5 | −1.53 | −1.30 |

*Log reduction in CFU/mL compared to Day 0, a negative number indicates log growth (i.e., cell growth).

### Example 6. Antimicrobial Challenge Testing of Foaming Hand Soap Treated with Sodium Benzoate and Cationic Polymers

### A. Antimicrobial Challenge Testing of Foaming Hand Soap at pH 7.0

Using the methods described in Example 2A and Example 2B, antimicrobial challenge testing was performed with foaming hand soap portions (pH 7.0) treated with a combination of sodium benzoate at a final concentration ranging from 0.1% to 1% and at least one of the cationic polymers selected from polymer nos. 1-9 at a final concentration ranging from 0.000625% to 0.09%. The final concentrations of sodium benzoate and polymer nos. 1-9 in the different portions are Indicated in Tables 18A-E and 19A-E.

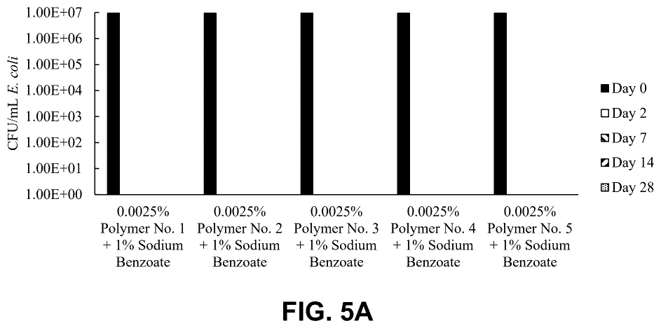

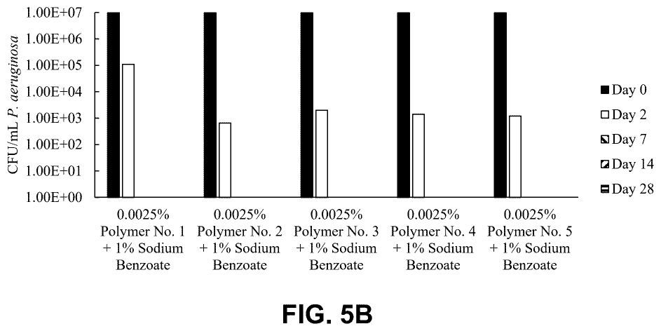

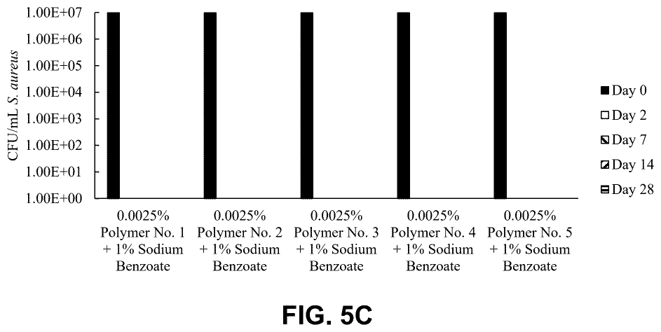

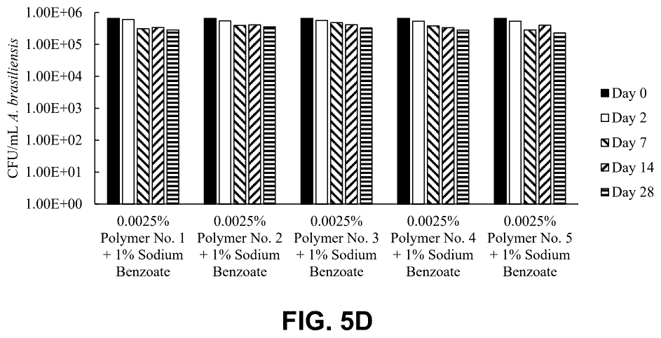

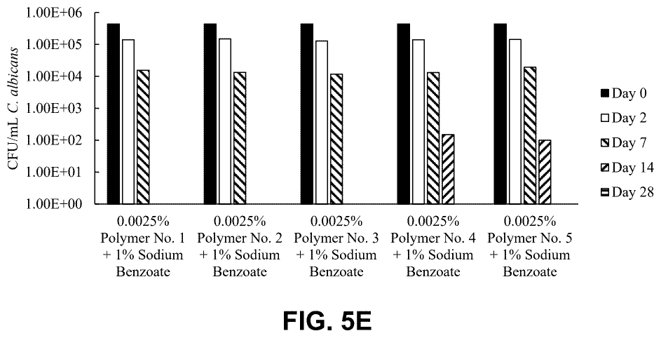

Viable microbial cell counts in foaming hand soap portions treated with polymer nos. 1-5 and sodium benzoate are reported in FIGS. 5A-E. The preservative efficacies of polymer nos. 1-5 together with sodium benzoate are shown in Tables 18A-E. For all bacterial strains tested, an approximate 7-log reduction in CFU/mL was observed by day 7 for all combinations tested. When challenged with A. brasiliensis, only a negligible change in CFU/mL was observed for all combinations tested. When challenged with C. albicans, a reduction of about 5-log in CFU/mL was observed by day 28 for all combinations tested.

### Tables 18A-E. Preservative Efficacies of Polymer Nos. 1-5 in Combination with Sodium Benzoate Against 5 Challenge Microorganisms in Foaming Hand Soap at pH 7.0

TABLE 18A
E. coli

| Sample (dosage) | Day 2* | Day 7* | Day 14* | Day 28* |
|---|---|---|---|---|
| Polymer No. 1 (0.0025%) + | 6.98 | 6.98 | 6.98 | 6.98 |
| Sodium Benzoate (1%) | | | | |
| Polymer No. 2 (0.0025%) + | 6.98 | 6.98 | 6.98 | 6.98 |
| Sodium Benzoate (1%) | | | | |
| Polymer No. 3 (0.0025%) + | 6.98 | 6.98 | 6.98 | 6.98 |
| Sodium Benzoate (1%) | | | | |
| Polymer No. 4 (0.0025%) + | 6.98 | 6.98 | 6.98 | 6.98 |
| Sodium Benzoate (1%) | | | | |
| Polymer No. 5 (0.0025%) + | 6.98 | 6.98 | 6.98 | 6.98 |
| Sodium Benzoate (1%) | | | | |

TABLE 18B
P. aeruginosa

| Sample (dosage) | Day 2* | Day 7* | Day 14* | Day 28* |
|---|---|---|---|---|
| Polymer No. 1 (0.0025%) + | 1.95 | 6.99 | 6.99 | 6.99 |
| Sodium Benzoate (1%) | | | | |
| Polymer No. 2 (0.0025%) + | 4.18 | 6.99 | 6.99 | 6.99 |
| Sodium Benzoate (1%) | | | | |
| Polymer No. 3 (0.0025%) + | 3.69 | 6.99 | 6.99 | 6.99 |
| Sodium Benzoate (1%) | | | | |
| Polymer No. 4 (0.0025%) + | 3.85 | 6.99 | 6.99 | 6.99 |
| Sodium Benzoate (1%) | | | | |
| Polymer No. 5 (0.0025%) + | 3.91 | 6.99 | 6.99 | 6.99 |
| Sodium Benzoate (1%) | | | | |

TABLE 18C
S. aureus

| Sample (dosage) | Day 2* | Day 7* | Day 14* | Day 28* |
|---|---|---|---|---|
| Polymer No. 1 (0.0025%) + | 6.99 | 6.99 | 6.99 | 6.99 |
| Sodium Benzoate (1%) | | | | |
| Polymer No. 2 (0.0025%) + | 6.99 | 6.99 | 6.99 | 6.99 |
| Sodium Benzoate (1%) | | | | |
| Polymer No. 3 (0.0025%) + | 6.99 | 6.99 | 6.99 | 6.99 |
| Sodium Benzoate (1%) | | | | |
| Polymer No. 4 (0.0025%) + | 6.99 | 6.99 | 6.99 | 6.99 |
| Sodium Benzoate (1%) | | | | |
| Polymer No. 5 (0.0025%) + | 6.99 | 6.99 | 6.99 | 6.99 |
| Sodium Benzoate (1%) | | | | |

TABLE 18D
A. brasiliensis

| Sample (dosage) | Day 2* | Day 7* | Day 14* | Day 28* |
|---|---|---|---|---|
| Polymer No. 1 (0.0025%) + | 0.04 | 0.33 | 0.29 | 0.36 |
| Sodium Benzoate (1%) | | | | |
| Polymer No. 2 (0.0025%) + | 0.08 | 0.22 | 0.21 | 0.26 |
| Sodium Benzoate (1%) | | | | |
| Polymer No. 3 (0.0025%) + | 0.07 | 0.13 | 0.20 | 0.30 |
| Sodium Benzoate (1%) | | | | |
| Polymer No. 4 (0.0025%) + | 0.09 | 0.24 | 0.29 | 0.37 |
| Sodium Benzoate (1%) | | | | |
| Polymer No. 5 (0.0025%) + | 0.09 | 0.36 | 0.22 | 0.46 |
| Sodium Benzoate (1%) | | | | |

TABLE 18E
C. albicans

| Sample (dosage) | Day 2* | Day 7* | Day 14* | Day 28* |
|---|---|---|---|---|
| Polymer No. 1 (0.0025%) + | 0.50 | 1.45 | 5.64 | 5.64 |
| Sodium Benzoate (1%) | | | | |
| Polymer No. 2 (0.0025%) + | 0.47 | 1.52 | 5.64 | 5.64 |
| Sodium Benzoate (1%) | | | | |
| Polymer No. 3 (0.0025%) + | 0.53 | 1.57 | 5.64 | 5.64 |
| Sodium Benzoate (1%) | | | | |
| Polymer No. 4 (0.0025%) + | 0.50 | 1.52 | 3.47 | 5.64 |
| Sodium Benzoate (1%) | | | | |
| Polymer No. 5 (0.0025%) + | 0.49 | 1.36 | 3.64 | 5.64 |
| Sodium Benzoate (1%) | | | | |

*Log reduction in CFU/mL compared to Day 0, negative number indicates log increase in CFU/mL (i.e., cell growth).

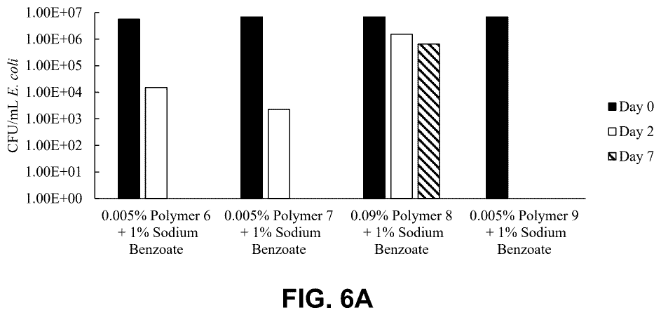

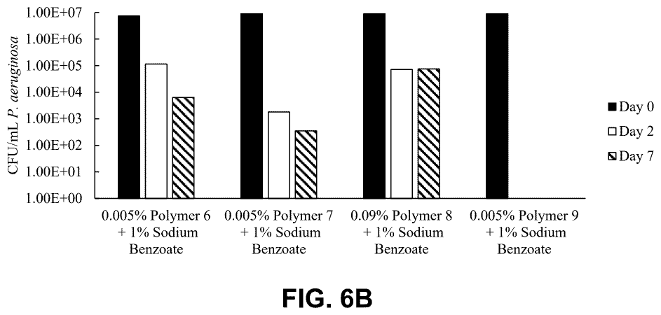

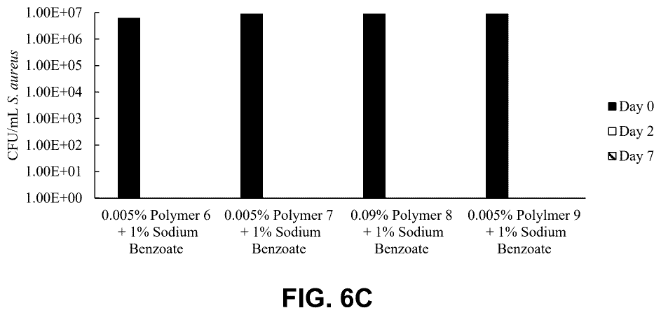

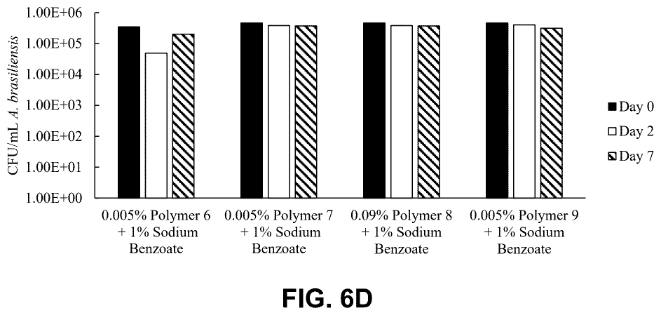

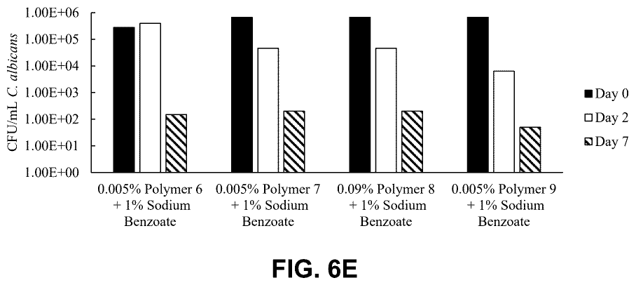

Viable microbial cell counts in different foaming hand soap portions treated with polymer nos. 6-9 and sodium benzoate are reported in FIGS. 6A-E. The preservative efficacies of polymer nos. 6-9 and sodium benzoate are shown in Tables 19A-E. When challenged by E. coli, each polymer-sodium benzoate combination achieved a greater log reduction in CFU/mL than the corresponding polymer alone (see results in Example 5), with the exception of polymer no. 9 which demonstrated similar preservative efficacy with and without the presence of sodium benzoate (FIGS. 4A and 6A; Tables 16A and 19A). When challenged by S. aureus, all the polymers achieved similar preservative efficacy, whether alone or in combination with sodium benzoate, except for polymer no. 8, which was slightly less effective alone (FIGS. 4C and 6C; Tables 16C and 19C). When challenged by A. brasiliensis, none of the polymers and polymer-sodium benzoate combinations resulted in any significant reduction in CFU/mL (FIGS. 4D and 6D; Tables 16D and 19D). When challenged by C. albicans, about 2-log to 4-log reductions in CFU/mL were observed for all polymers and polymer-sodium benzoate combinations by day 7, with the exception of polymer no. 8, which had a negligible effect on C. albicans viable cell count, but achieved a 3.5-log reduction in CFU/mL by day 7 in the presence of sodium benzoate (FIGS. 4E and 6E; Tables 16E and 19E).

### Tables 19A-E. Preservative Efficacy of Polymer Nos. 6-9 in Combination with Sodium Benzoate Against 5 Challenge Microorganisms in Foaming Hand Soap at pH 7.0

TABLE 19A
E. coli

| Sample (dosage) | Day 2* | Day 7* |
|---|---|---|
| Polymer No. 6 (0.005%) + Sodium Benzoate (1%) | 2.57 | 6.75 |
| Polymer No. 7 (0.005%) + Sodium Benzoate (1%) | 3.48 | 6.84 |
| Polymer No. 8 (0.09%) + Sodium Benzoate (1%) | 0.66 | 1.02 |
| Polymer No. 9 (0.005%) + Sodium Benzoate (1%) | 6.84 | 6.84 |

TABLE 19B
P. aeruginosa

| Sample (dosage) | Day 2* | Day 7* |
|---|---|---|
| Polymer No. 6 (0.005%) + Sodium Benzoate (1%) | 1.81 | 3.07 |
| Polymer No. 7 (0.005%) + Sodium Benzoate (1%) | 3.70 | 4.41 |
| Polymer No. 8 (0.09%) + Sodium Benzoate (1%) | 2.10 | 2.08 |
| Polymer No. 9 (0.005%) + Sodium Benzoate (1%) | 6.95 | 6.95 |

TABLE 19C
S. aureus

| Sample (dosage) | Day 2* | Day 7* |
|---|---|---|
| Polymer No. 6 (0.005%) + Sodium Benzoate (1%) | 6.78 | 6.78 |
| Polymer No. 7 (0.005%) + Sodium Benzoate (1%) | 6.94 | 6.94 |
| Polymer No. 8 (0.09%) + Sodium Benzoate (1%) | 6.94 | 6.94 |
| Polymer No. 9 (0.005%) + Sodium Benzoate (1%) | 6.94 | 6.94 |

TABLE 19D
A. brasiliensis

| Sample (dosage) | Day 2* | Day 7* |
|---|---|---|
| Polymer No. 6 (0.005%) + Sodium Benzoate (1%) | 0.85 | 0.24 |
| Polymer No. 7 (0.005%) + Sodium Benzoate (1%) | 0.08 | 0.09 |
| Polymer No. 8 (0.09%) + Sodium Benzoate (1%) | 0.08 | 0.09 |
| Polymer No. 9 (0.005%) + Sodium Benzoate (1%) | 0.06 | 0.17 |

TABLE 19E
C. albicans

| Sample (dosage) | Day 2* | Day 7* |
|---|---|---|
| Polymer No. 6 (0.005%) + Sodium Benzoate (1%) | −0.15 | 3.27 |
| Polymer No. 7 (0.005%) + Sodium Benzoate (1%) | 1.16 | 3.53 |
| Polymer No. 8 (0.09%) + Sodium Benzoate (1%) | 1.16 | 3.53 |
| Polymer No. 9 (0.005%) + Sodium Benzoate (1%) | 2.02 | 4.13 |

*Log reduction in CFU/mL compared to Day 0, negative number indicates log increase in CFU/mL (i.e., cell growth).

Using the method described in Example 2A, antibacterial challenge testing was performed with foaming hand soap portions (pH 7.0) treated with a combination of sodium benzoate at a final concentration ranging from 0.1% to 0.6% and each of polymer nos. 1-9, with varying degrees of efficacy. The preservative efficacies of various levels of sodium benzoate in combination with polymer no. 4 are shown in Table 20. Reductions in CFU/mL were observed in foaming hand soap portions containing 0.6% sodium benzoate and 0.0025% polymer no. 4 by day 2; and no countable colonies could be observed in those portions by day 7. The combination of 0.4% sodium benzoate and 0.0025% polymer no. 4 resulted in a reduction in CFU/mL by day 2 and an even further reduction by day 7. This was also true for the portions containing 0.2% sodium benzoate and 0.0025% polymer no. 4 and, but reductions in those portions were not as remarkable at neither day 2 nor day 7. In portions containing 0.1% sodium benzoate and 0.0025% polymer no. 4, a modest reduction in CFU/mL was observed at day 2, but an increase in bacterial growth was observed by day 7 compared to day 0.

TABLE 20
Preservative efficacies of cationic polymer in combination
with low levels of sodium benzoate (<1%) against
bacteria in foaming hand soap at pH value of 7.0

| Sample (dosage) | Day 2* | Day 7* |
|---|---|---|
| Polymer No. 4 (0.0025%) + Sodium Benzoate (0.6%) | 4.21 | 6.47 |
| Polymer No. 4 (0.0025%) + Sodium Benzoate (0.4%) | 3.23 | 5.47 |
| Polymer No. 4 (0.0025%) + Sodium Benzoate (0.2%) | 2.21 | 2.82 |
| Polymer No. 4 (0.0025%) + Sodium Benzoate (0.1%) | 1.05 | −0.53 |

*Log reduction in CFU/mL compared to day 0, negative number indicates log growth (i.e., cell growth).

### B. Antimicrobial Challenge Testing of Foaming Hand Soap at pH 6.5, 7.0, 7.5, 8.0, or 8.5

Using the method described in Example 2A, antibacterial challenge testing was performed with foaming hand soap portions adjusted to pH values of 6.5, 7.0, or 7.5 and treated with a combination of polymer no. 4 and sodium benzoate. The final concentrations of polymer no. 4 and sodium benzoate in the different portions are indicated in Table 21. The preservative efficacies of the combination of polymer no. 4 and sodium benzoate are shown in Table 21. The combination of polymer no. 4 and sodium benzoate achieved about a 6-log reduction in CFU/mL by day 7 at all pH values tested (Table 21). In contrast, polymer no. 4 alone led to no reduction in CFU/mL by day 7 at any of the pH values tested (Table 17).

TABLE 21
Preservative efficacies of polymer no. 4 in combination with sodium
benzoate against bacteria in foaming hand soap at pH 6.5, 7.0, or 7.5

| Sample (dosage) | pH | Day 2* | Day 7* |
|---|---|---|---|
| Polymer No. 4 (0.0025%) + Sodium Benzoate (0.5%) | 6.5 | 6.11 | 6.11 |
| Polymer No. 4 (0.0025%) + Sodium Benzoate (1%) | 7.0 | 6.07 | 6.07 |
| Polymer No. 4 (0.0025%) + Sodium Benzoate (1%) | 7.5 | 3.93 | 6.14 |

*Log reduction in CFU/mL compared to Day 0, a negative number indicates log growth (i.e., cell growth).

Using the method described in Example 2B, confirmatory antimicrobial challenge testing was performed with foaming hand soap portions adjusted to pH values of pH 6.5, 7.0, 7.5, 8.0, or 8.5 and treated with polymer no. 4 and sodium benzoate. The final concentrations of polymer no. 4 and sodium benzoate in the different portions and their preservative efficacies are indicated in Tables 22A-E. For each of the bacterial strains tested, all combinations achieved about a 7-log reduction in CFU/mL by day 7. Negligible change in CFU/mL was observed in portions challenged by A. brasiliensis. When challenged by C. albicans, about 5-log reductions in CFU/mL were observed by day 18 for all combinations tested, except for the combinations tested at pH 7.5, which had a more modest reduction of about a 3-log reduction in CFU/mL.

### Tables 22A-E. Preservative Efficacies of Polymer No. 4 and Sodium Benzoate Against 5 Challenge Microorganisms in Foaming Hand Soap at pH 6.5 7.0, 7.5, 8.0, or 8.5

TABLE 22A
E. coli

| Sample (dosage) | pH | Day 2* | Day 7* | Day 18* |
|---|---|---|---|---|
| Polymer No. 4 (0.000625%) + | 6.5 | 6.80 | 6.80 | 6.80 |
| Sodium Benzoate (0.5%) | | | | |
| Polymer No. 4 (0.000625%) + | 7.0 | 6.80 | 6.80 | 6.80 |
| Sodium Benzoate (1%) | | | | |
| Polymer No. 4 (0.000625%) + | 7.5 | 6.80 | 6.80 | 6.80 |
| Sodium Benzoate (1%) | | | | |
| Polymer No. 4 (0.000625%) + | 8.0 | 6.75 | 6.75 | 6.75 |
| Sodium Benzoate (1%) | | | | |
| Polymer No. 4 (0.000625%) + | 8.5 | 6.75 | 6.75 | 6.75 |
| Sodium Benzoate (1%) | | | | |

TABLE 22B
P. aeruginosa

| Sample (dosage) | pH | Day 2* | Day 7* | Day 18* |
|---|---|---|---|---|
| Polymer No. 4 (0.000625%) + | 6.5 | 6.85 | 6.85 | 6.85 |
| Sodium Benzoate (0.5%) | | | | |
| Polymer No. 4 (0.000625%) + | 7.0 | 3.94 | 6.85 | 6.85 |
| Sodium Benzoate (1%) | | | | |
| Polymer No. 4 (0.000625%) + | 7.5 | 6.85 | 6.85 | 6.85 |
| Sodium Benzoate (1%) | | | | |
| Polymer No. 4 (0.000625%) + | 8.0 | 2.81 | 6.87 | 6.87 |
| Sodium Benzoate (1%) | | | | |
| Polymer No. 4 (0.000625%) + | 8.5 | 2.67 | 6.87 | 6.87 |
| Sodium Benzoate (1%) | | | | |

TABLE 22C
S. aureus

| Sample (dosage) | pH | Day 2* | Day 7* | Day 18* |
|---|---|---|---|---|
| Polymer No. 4 (0.000625%) + | 6.5 | 6.82 | 6.82 | 6.82 |
| Sodium Benzoate (0.5%) | | | | |
| Polymer No. 4 (0.000625%) + | 7.0 | 6.82 | 6.82 | 6.82 |
| Sodium Benzoate (1%) | | | | |
| Polymer No. 4 (0.000625%) + | 7.5 | 6.82 | 6.82 | 6.82 |
| Sodium Benzoate (1%) | | | | |
| Polymer No. 4 (0.000625%) + | 8.0 | 6.78 | 6.78 | 6.78 |
| Sodium Benzoate (1%) | | | | |
| Polymer No. 4 (0.000625%) + | 8.5 | 6.78 | 6.78 | 6.78 |
| Sodium Benzoate (1%) | | | | |

TABLE 22D
A. brasiliensis

| Sample (dosage) | pH | Day 2* | Day 7* | Day 18* |
|---|---|---|---|---|
| Polymer No. 4 (0.000625%) + | 6.5 | 0.19 | 0.18 | 0.26 |
| Sodium Benzoate (0.5%) | | | | |
| Polymer No. 4 (0.000625%) + | 7.0 | 0.01 | 0.19 | 0.29 |
| Sodium Benzoate (1%) | | | | |
| Polymer No. 4 (0.000625%) + | 7.5 | 0.01 | 0.02 | 0.13 |
| Sodium Benzoate (1%) | | | | |
| Polymer No. 4 (0.000625%) + | 8.0 | −0.09 | −0.01 | 0.04 |
| Sodium Benzoate (1%) | | | | |
| Polymer No. 4 (0.000625%) + | 8.5 | −0.06 | 0.08 | 0.01 |
| Sodium Benzoate (1%) | | | | |

TABLE 22E
C. albicans

| Sample (dosage) | pH | Day 2* | Day 7* | Day 18* |
|---|---|---|---|---|
| Polymer No. 4 (0.000625%) + | 6.5 | 0.19 | 1.57 | 5.39 |
| Sodium Benzoate (0.5%) | | | | |
| Polymer No. 4 (0.000625%) + | 7.0 | 0.28 | 1.73 | 5.39 |
| Sodium Benzoate (1%) | | | | |
| Polymer No. 4 (0.000625%) + | 7.5 | 0.21 | 0.46 | 2.85 |
| Sodium Benzoate (1%) | | | | |
| Polymer No. 4 (0.000625%) + | 8.0 | 1.00 | 0.70 | 5.45 |
| Sodium Benzoate (1%) | | | | |
| Polymer No. 4 (0.000625%) + | 8.5 | 0.21 | 0.61 | 5.45 |
| Sodium Benzoate (1%) | | | | |

*Log reduction in CFU/mL compared to Day 0, negative number indicates log increase in CFU/mL (i.e., cell growth).

### Example 7. Antimicrobial Challenge Testing of Foaming Hand Soap Treated with Sodium Benzoate, a Cationic Polymer, and an Antimicrobial Chemical at pH 7.0

Using the method described in Example 2B, confirmatory antimicrobial challenge testing was performed with foaming hand soap portions (pH 7.0) containing 0.0025% polymer no. 4, 1% sodium benzoate, and 1% caprylyl glycol. The preservative efficacies are reported in Table 23. For each of the fungal strains there was about a 5-log reduction in CFU/mL by day 14.

TABLE 23
Preservative efficacies of polymer no. 4 in combination
with sodium benzoate and caprylyl glycol against
yeast and mold in foaming hand soap at pH 7.0

| Sample (dosage) | Microorganism | Day 2* | Day 7* | Day 14* |
|---|---|---|---|---|
| Polymer No. 4 (0.0025%) + | A. brasiliensis | 2.24 | 3.37 | 5.67 |
| Sodium Benzoate (1%) + | C. albicans | 3.35 | 5.75 | 5.75 |
| Caprylyl glycol (1%) | | | | |

*Log reduction in CFU/mL compared to Day 0, negative number indicates log increase in CFU/mL (i.e., cell growth).

### Example 8. Antimicrobial Challenge Testing of Personal Care Products Treated with Sodium Benzoate and/or a Cationic Polymer, and Optionally One or More Additional Antimicrobial Chemicals

Personal care products such as micellar cleanser, hair conditioner, body lotion, and body wash are prepared as described in Tables 5-8, respectively, and adjusted to pH 7.0. Antimicrobial challenge testing as disclosed in Examples 2A and 2B is performed with untreated products and products treated with a polymer selected from polymer nos. 1-9, sodium benzoate, or a combination of a polymer selected from polymer nos. 1-9 and sodium benzoate. Optionally the antimicrobial challenge testing is also performed with products treated with a polymer selected from polymer nos. 1-9, sodium benzoate, and one or more additional antimicrobial chemicals. In the treated products, the final concentrations of the polymer and sodium benzoate are 0.0025% and 1% respectively.

Viable cell counts in untreated and treated personal care products described above are recorded. The preservative efficacies of sodium benzoate, polymer nos. 1-9, the combination of sodium benzoate and a polymer selected from polymer nos. 1-9, and optionally the combination of sodium benzoate, a polymer selected from polymer nos. 1-9, and one or more additional antimicrobial chemicals are compared as log reductions in CFU/mL by day 2 and day 7 compared to day 0 respectively.

### Example 9. Antimicrobial Challenge Testing of Household Products Treated with Sodium Benzoate and/or a Cationic Polymer, and Optionally One or More Additional Antimicrobial Chemicals

Household products such as household cleaner, laundry detergent, and dish soap are prepared as described in Tables 9-11 respectively and adjusted to pH 7.0. Antimicrobial challenge testing as disclosed in Examples 2A and 2B is performed with untreated products and products treated with a polymer selected from polymer nos. 1-9, sodium benzoate, or a combination of a polymer selected from polymer nos. 1-9 and sodium benzoate. Optionally the antimicrobial challenge testing is also performed with products treated with a polymer selected from polymer nos. 1-9, sodium benzoate, and one or more additional antimicrobial chemicals. In the treated products, the final concentrations of the polymer and sodium benzoate are 0.0025% and 1% respectively.

Viable microbial cell counts in untreated and treated household products described above are recorded. The preservative efficacies of sodium benzoate, polymer no. 1-9, the combination of sodium benzoate and a polymer selected from polymer nos. 1-9, and optionally the combination of sodium benzoate, a polymer selected from polymer nos. 1-9, and one or more additional antimicrobial chemicals are compared as log reductions in CFU/mL by day 2 and day 7 compared to day 0 respectively.

### Example 10. Antimicrobial Challenge Testing of a Paint, Coating, or Adhesive Product Treated with Sodium Benzoate and/or a Cationic Polymer, and Optionally One or More Antimicrobial Chemicals

Paint is prepared as described in Table 12 and adjusted to pH 7.0. Antimicrobial challenge testing as disclosed in Examples 2A and 2B is performed with untreated paint and paint treated with a polymer selected from polymer nos. 1-9, sodium benzoate, or a combination of a polymer selected from polymer nos. 1-9 and sodium benzoate. Optionally the antimicrobial challenge testing is also performed with products treated with a polymer selected from polymer nos. 1-9, sodium benzoate, and one or more additional antimicrobial chemicals. In the treated products, the final concentrations of the polymer and sodium benzoate are 0.0025% and 1% respectively.

Viable microbial cell counts in untreated and treated paint described above are recorded. The preservative efficacies of sodium benzoate, polymer no. 1-9, the combination of sodium benzoate and a polymer selected from polymer nos. 1-9, and optionally the combination of sodium benzoate, a polymer selected from polymer nos. 1-9, and one or more additional antimicrobial chemicals are compared as log reductions in CFU/mL by day 2 and day 7 compared to day 0 respectively.

1-35. (canceled)

36. A product comprising an antimicrobial composition, wherein the antimicrobial composition comprises an ammonium-containing cationic polymer and sodium benzoate, wherein the concentration of sodium benzoate in the product is about 1% or lower by weight, and wherein the pH of the product is 6.0 or greater.

37. A product comprising an antimicrobial composition, wherein the antimicrobial composition comprises an ammonium-containing cationic polymer and sodium benzoate, wherein the sodium benzoate in the product is about 0.5% or lower by weight and the pH of the product is about 7.0 or lower, and wherein the product has improved antimicrobial efficacy compared to an identical product that does not comprise the ammonium-containing cationic polymer.

38. The product of claim 36, wherein the ammonium-containing cationic polymer has a molecular weight of about 800 g/mol to about 1,000,000 g/mol.

39. The product of claim 36, wherein the ammonium-containing cationic polymer is a primary ammonium-containing polymer, a secondary ammonium-containing polymer, a tertiary ammonium-containing polymer, a quaternary ammonium-containing polymer, and/or a copolymer thereof.

40. The product of claim 36, wherein the product is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.

41. The product of claim 36, wherein the product is at about pH 6.0 to about pH 8.5.

42. The product of claim 36, further comprising at least an antimicrobial enzyme, an antimicrobial peptide, an antimicrobial protein, and/or an additional antimicrobial chemical.

43. The product of claim 42, wherein the at least one additional antimicrobial chemical is selected from phenoxyethanol, caprylyl glycol, ethylhexylglycerin, hexanediol, propanediol, coco betaine, citric acid, sorbic acid, ethylenediaminetetraacetic acid (EDTA), and chitosan.

44. An antimicrobial composition comprising an ammonium-containing cationic polymer and sodium benzoate, wherein the antimicrobial composition has antimicrobial activity from about pH 6.0 to about pH 8.5 when incorporated into a product at amounts of less than 1% sodium benzoate in the product.

45. The antimicrobial composition of claim 44, wherein the ammonium-containing cationic polymer has a molecular weight of about 800 g/mol to about 1,000,000 g/mol.

46. The antimicrobial composition of claim 44, further comprising at least an antimicrobial enzyme, an antimicrobial peptide, an antimicrobial protein, and/or an additional antimicrobial chemical.

47. The antimicrobial composition of claim 46, wherein the at least one additional antimicrobial chemical is selected from phenoxyethanol, caprylyl glycol, ethylhexylglycerin, hexanediol, propanediol, coco betaine, citric acid, sorbic acid, ethylenediaminetetracetic acid (EDTA), and chitosan.

48. The antimicrobial composition of claim 44, wherein the antimicrobial composition is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product, and sodium benzoate is about 1% or lower by weight.

49. A method of preserving or increasing the shelf life of a product comprising incorporating the antimicrobial composition of claim 44 into the product in an amount effective to provide antimicrobial activity in comparison to an identical product that does not comprise the antimicrobial composition.

50. The method of claim 49, wherein the product is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.

51. The product of claim 37, further comprising at least an antimicrobial enzyme, an antimicrobial peptide, an antimicrobial protein, and/or an additional antimicrobial chemical.

52. The product of claim 37, wherein the product is at about pH 2.5 to about pH 7.0.

53. An antimicrobial composition comprising an ammonium-containing cationic polymer and sodium benzoate, wherein the antimicrobial composition has antimicrobial activity at about pH 7.0 or lower when incorporated into a product at amounts of less than 0.5% sodium benzoate in the product, and wherein the antimicrobial composition has improved antimicrobial efficacy compared to an identical composition that does not comprise the ammonium-containing cationic polymer.

54. The antimicrobial composition of claim 53, wherein the product is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.

55. The antimicrobial composition of claim 53, further comprising at least an antimicrobial enzyme, an antimicrobial peptide, an antimicrobial protein, and/or an additional antimicrobial chemical.

56. A method of preserving or increasing the shelf life of a product comprising incorporating the antimicrobial composition of claim 53 into the product in an amount effective to provide antimicrobial activity in comparison to an identical product that does not comprise the antimicrobial composition.

57. The method of claim 56, wherein the product is a personal care, household, industrial, industrial and institutional cleaning, industrial and recreational water, cooling water, food, beverage, pharmaceutical, cosmetic, healthcare, marine, paint, coating, oil, gas, plastic, packaging, agricultural, latex, pulp, or paper product.
